(19) United States
(12) Patent Application Publication
(10) Pub. No.: US 2026/0249948 A1
(43) Pub. Date: Aug. 27, 2026

(54) MICROMOBILITY DEVICE WITH PEDAL CLOCKING AND HAPTIC FEEDBACK

(71) Applicant: Also, Inc., Palo Alto, CA (US)

(72) Inventors: Jonathan Louis HALL, Menlo Park, CA (US); Christopher YU, Menlo Park, CA (US); Patrick HARRINGTON, Asheville, NC (US)

(73) Assignee: Also, Inc., Palo Alto, CA (US)

(21) Appl. No.: 19/550,423

(22) Filed: Feb. 26, 2026

Related U.S. Application Data
(60) Provisional application No. 63/902,809, filed on Oct. 21, 2025.
(60) Provisional application No. 63/764,151, filed on Feb. 27, 2025.

(51) Int. Cl. B62M 6/50; B62J 6/056; B62J 50/21

(52) U.S. Cl. CPC B62M 6/50; B62J 6/056; B62J 50/21

(57) ABSTRACT

A vehicle can include a frame, a first wheel and a second wheel rotatably coupled with the frame, and a drive unit coupled with the frame. The drive unit can include a pedal assembly that can receive mechanical input from a user and a motor generator coupled with the pedal assembly. The motor generator can include a rotor and windings. The motor generator can operate in a generator mode and can vary an amount of resistive torque exerted on the pedal assembly and an amount of power generated per rotation of the rotor. The motor generator can operate in a transducer mode to generate a plurality of torque values, each transmitted to the pedal assembly. A transition between the plurality of torque values can produce a tactile sensation by the pedal assembly. The generator mode and the transducer mode can be operable concurrently and non-concurrently.

### CROSS-REFERENCE TO RELATED APPLICATIONS

This U.S. Patent Application claims the benefit of and priority to U.S. Provisional Application No. 63/902,809, filed October 21, 2025, and U.S. Provisional Application No. 63/764,151, filed February 27, 2025, the entire disclosures of each of which is hereby incorporated by reference herein for all purposes.

### BACKGROUND

Vehicles such as bicycles can include an electric motor that receives power from a battery.

### SUMMARY

At least one aspect is directed to a vehicle. The vehicle can include a frame. The vehicle can include a first wheel and a second wheel rotatably coupled with the frame. The vehicle can include a drive unit coupled with the frame. The drive unit can include a pedal assembly that can receive mechanical input from a user. The drive unit can include a motor generator coupled with the pedal assembly. The motor generator can include a rotor and windings. The motor generator can operate in a generator mode to generate electrical current based on the mechanical input applied by the user to the pedal assembly. The generator mode can vary an amount of resistive torque exerted on the pedal assembly and an amount of power generated per rotation of the rotor. The motor generator can operate in a transducer mode to generate a plurality of torque values, each transmitted to the pedal assembly. A transition between the plurality of torque values can produce a tactile sensation by the pedal assembly. The generator mode and the transducer mode can be operable concurrently and non-concurrently.

At least one aspect is directed to a vehicle. The vehicle can include a frame. The vehicle can include a first wheel and a second wheel rotatably coupled with the frame. The vehicle can include a drive unit that can rotate the second wheel. The drive unit can be coupled with the frame. The drive unit include a pedal assembly that can receive a mechanical input from a user. The drive unit can include a motor generator having a rotor and windings. The motor generator can be coupled with the pedal assembly and can exert a resistive torque on the pedal assembly while generating electrical current based on the mechanical input from the user. The vehicle can include a control device that can vary, based on the pedal assembly moving, current flowing through the windings of the motor generator to vary the resistive torque exerted on the pedal assembly to provide haptic feedback via the pedal assembly.

At least one aspect is directed to a method of manufacturing a vehicle. The method can include providing a frame. The method can include rotatably coupling a first wheel and a second wheel with the frame. The method can include coupling a drive unit with the frame. The can include a pedal assembly that can receive mechanical input from a user. The drive unit can include a motor generator coupled with the pedal assembly. The motor generator can operate in a generator mode to generate electrical current based on the mechanical input applied by the user to the pedal assembly. The motor generator can operate in a transducer mode to generate a plurality of torque values. Each of the plurality of torque values can be transmitted to the pedal assembly. A transition between the plurality of torque values can produce a tactile sensation by the pedal assembly. The generator mode and the transducer mode can be operable concurrently and non-concurrently.

At least one aspect is directed to a method. The method can include providing a vehicle. The vehicle can include a frame. The vehicle can include a first wheel and a second wheel rotatably coupled with the frame. The vehicle can include a drive unit coupled with the frame. The drive unit can include a pedal assembly and a motor generator. The pedal assembly can receive mechanical input from a user. The motor generator can be coupled with the pedal assembly. The motor generator can operate in a generator mode to generate electrical current based on the mechanical input applied by the user to the pedal assembly. The motor generator can operate in a transducer mode to generate a plurality of torque values. Each of the plurality of torque values can be transmitted to the pedal assembly. A transition between the plurality of torque values can produce a tactile sensation by the pedal assembly. The generator mode and the transducer mode can be operable concurrently and non-concurrently.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example vehicle, in accordance with some aspects.

FIG. 2 depicts a drive unit of a vehicle, in accordance with some aspects.

FIG. 3 is a block diagram of an example drive unit of a vehicle, in accordance with some aspects.

FIG. 4 depicts a vehicle that is configured to provide haptic feedback to a user via a pedal assembly, in accordance with some aspects.

FIG. 5 depicts a vehicle that is configured to actuate a pedal assembly, in accordance with some aspects.

FIG. 6 depicts a vehicle that is configured to actuate a pedal assembly, in accordance with some aspects.

FIG. 7 depicts a pedal assembly of a vehicle in an ingress/egress position, in accordance with some aspects.

FIG. 8 depicts a pedal assembly of a vehicle in an ingress/egress position, in accordance with some aspects.

FIG. 9 depicts a pedal assembly of a vehicle in a launch position, in accordance with some aspects.

FIG. 10 depicts a pedal assembly of a vehicle in an ingress/egress position, in accordance with some aspects.

FIG. 11 depicts a pedal assembly of a vehicle in a launch position, in accordance with some aspects.

FIG. 12 is a flow chart of a control operation for actuating a pedal assembly of a vehicle, in accordance with some aspects.

FIG. 13 is a block diagram illustrating an architecture for a computer system that can be employed to implement elements of the systems and methods described and illustrated herein, including, for example, the vehicle of FIGS. 1–12.

FIG. 14 depicts an example method of manufacturing a vehicle.

FIG. 15 depicts an example method of providing a vehicle.

### DETAILED DESCRIPTION

Following below are more detailed descriptions of various concepts related to, and implementations of, methods, apparatuses, and systems of integrating feedback systems into bicycles. The various concepts introduced above and discussed in greater detail below may be implemented in any of numerous ways.

The technical solutions are generally directed to a pedal-operated vehicle, including a micromobility device such as a bicycle (bike) or other pedal operated vehicle having at least one wheel (e.g., two wheels, four wheels). The vehicle can include at least one pedal assembly, at least one drive unit (e.g., a propulsion system), and at least one wheel. The drive unit can rotate the wheel to propel the vehicle. The pedal assembly can be coupled with the drive unit such that a mechanical force applied to the pedal assembly by a user can cause the drive unit to rotate the wheel to propel the vehicle. The drive unit can rotate the wheel in absence of a mechanical force provided by the user to the pedal assembly. For example, the vehicle can include a battery to power the drive unit without application of a mechanical force to the pedal assembly by the user. The vehicle can include a motor generator to cause movement of to the pedal assembly. The motor generator of the vehicle can cause a movement of the pedal independent of an action of a user (e.g., an action of a person riding the vehicle to move the pedal during operation).

For example, the motor generator can operate in a transducer mode to provide haptic feedback to a user via the pedal assembly, where the haptic feedback can be provided to the user whether the user is actively applying a mechanical force to the pedal to propel the vehicle or whether the drive unit is rotating the wheel in absence of a mechanical force applied to the pedal assembly by the user. The motor generator can provide haptic feedback to the user. For example, the motor generator can receive electrical energy and convert that electrical energy into a plurality of mechanical torque values applied to the pedal assembly. While a user pedals the pedal assembly to generate electrical current, the user can experience a base resistive torque resulting from the electrical load on the motor generator. For example, the motor generator can vary current flowing through its windings to vary the amount of resistive force the user experiences while pedaling. For example, if the crank assembly is mechanically coupled to a drive wheel, the motor generator may change a resistive profile (e.g., the resistive force experienced by the user) to account for such a mechanical connection.

The motor generator can rotate the pedal assembly to alter an angular position of a pedal or shaft of the pedal assembly. For example, the motor generator can move a shaft of the pedal assembly from a stopping position or an ingress/egress position (e.g., a position in which the shaft resides after the vehicle comes to a stop) to a starting position or a launch position (e.g., a position of the shaft that would normally be used to mechanically propel a bike, as such a position is (i) what a user may be used to when moving from a stop, and (ii) provide more leverage to generate current by the motor generator) in a pedal clocking operation. The starting position can be, for example, a position of the pedal assembly away from a top-dead-center position where application of a downward force by a user can readily and efficiently translate into rotational motion of the pedal assembly to propel the vehicle. In other examples, the motor generator can move a shaft of the pedal assembly to alter an angular position of the pedal or shaft of the pedal assembly to facilitate ingress or egress of a user in relation to the vehicle. For example, the motor generator can move the shaft or pedal of the pedal assembly to position the pedal assembly at a top-dead-center position to increase a space available for ingress or egress of a user when the user is mounting (e.g., getting onto) or dismounting (e.g., getting off of) the vehicle, such as when the vehicle is parked. The motor generator can actuate the pedal or the shaft of the pedal assembly. For example, the motor generator can actuate (e.g., move, rotate, vibrate, or otherwise actuate) one or both of the pedal or the shaft of the pedal assembly.

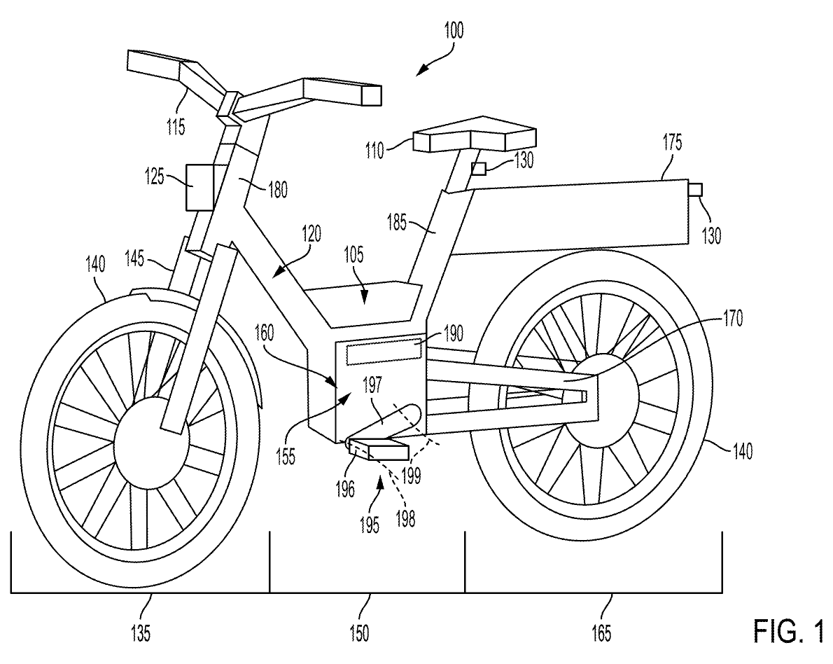

FIG. 1 depicts an example perspective view of a vehicle 100, shown as a bicycle 100. The vehicle 100 can be an electric bike 100 installed with at least one battery pack 105. The vehicle 100 can be a human-operated bike 100. The vehicle 100 can be or include a micromobility device such as single rider bicycles, tandem bicycles, cargo bicycles, motor-assist bicycles, pedicabs, electric-assist bicycles, road bicycles, mountain bicycles, unicycles, segways, or scooters, among others. In other examples, the vehicle 100 can include four wheels, with a driver position between left/right side wheels. The battery pack 105 can also be used as an energy storage system to power a building, such as a residential home or commercial building. The vehicle 100 can be fully electric or partially electric (e.g., pedal-powered) and further, the vehicle 100 can be fully autonomous, partially autonomous, semi-autonomous, or unmanned. The vehicle 100 can also be human operated or non-autonomous. A human operator or the rider of the vehicle 100 can sit on a saddle 110 to operate the vehicle 100. The rider of the vehicle 100 can steer, grip, balance, or otherwise control the vehicle 100 using the handlebar 115.

The vehicle 100 can include a frame 120. The frame 120 can support various components of the vehicle 100, such as a handlebar 115, the saddle 110, the battery 105, at least one front light assembly 125, and at least one rear light assembly 130. The frame 120 can span a front portion 135. The front portion 135 can support, be coupled with, or include, for example, a wheel 140 of the vehicle 100, a fork 145 of the vehicle 100, a head tube 180 of the vehicle 100, the handlebar 115, or the front light assembly 125, among other components. The vehicle 100 can include two or more wheels 140 (e.g., a front wheel 140 and a rear wheel 140). The frame 120 can span a middle portion 150 (e.g., a central portion). The middle portion 150 can support, be coupled with, or include, for example, the saddle 110, the battery 105, a drive unit 155 of the vehicle 100, a crank assembly 160 of the vehicle 100, or a top tube 185, among other components.

The frame 120 can include the middle portion 150 including the rear light assembly 130. The frame 120 can include a rear portion 165. The rear portion 165 can support, be coupled with, or include, for example, a rear wheel 140 of the vehicle 100, the rear light assembly 130, a drivetrain 172 of the vehicle 100, or a rear member 175 of the vehicle 100, among other components. The drivetrain 172 of the vehicle 100 can be a chain, gear, belt, or some combination thereof that couples the drive unit 155 with the rear wheel 140 of the vehicle 100 such that the drive unit 155 can rotate or drive the rear wheel 140. The rear member 175 of the vehicle 100 can be a rear fender, a rack configured to stow or support luggage or some other object, a child seat, a pet carrier, a basket, or some other object. The battery 105 can be disposed anywhere within the frame 120.

The vehicle 100 can include at least one battery 105 or battery pack 105 that can include at least one battery module or at least one battery cell. The battery 105 can be electrically coupled with the vehicle 100 (e.g., to the drive unit 155, to the front light assembly 125, the rear light assembly 130, or some other component(s)). For example, the battery 105 can provide electrical energy to the vehicle 100 to power the vehicle 100. For example, the battery 105 can provide electrical energy to the drive unit 155 to cause the drive unit 155 to operate (e.g., to rotate the wheel 140 of the vehicle 100). The battery 105 can be installed or placed within the vehicle 100. For example, the battery 105 can be installed on the frame 120 of the vehicle 100 within one or more of the front portion 135, the middle portion 150, or the rear portion 165. The battery 105 can be integrally coupled with the frame 120 such that it is not removable. The battery 105 can be detachably coupled with the frame 120 such that in can be removed (e.g., to charge the battery 105). The battery 105 can include or connect with at least one busbar, e.g., a current collector element. For example, the busbar can include electrically conductive material to connect or otherwise electrically couple the battery 105 with other electrical components of the vehicle 100 to provide electrical power to various systems or components of the vehicle 100, such as the front light assembly 125, the rear light assembly 130, or some other system.

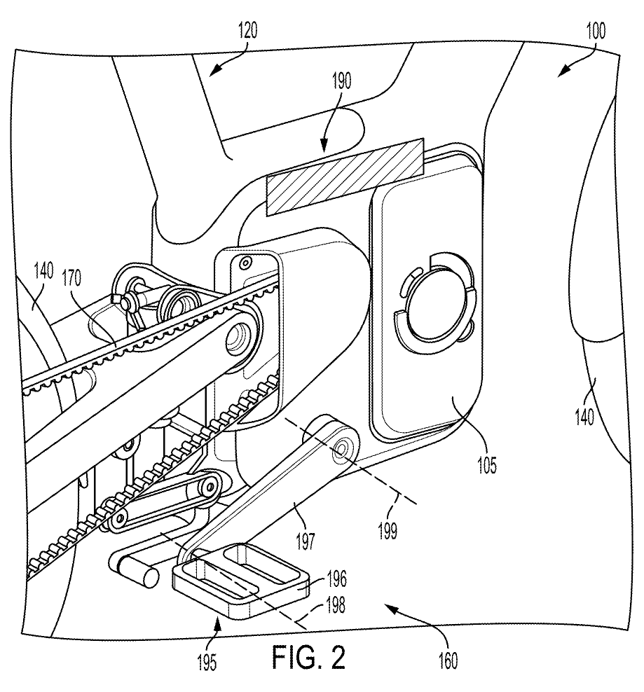

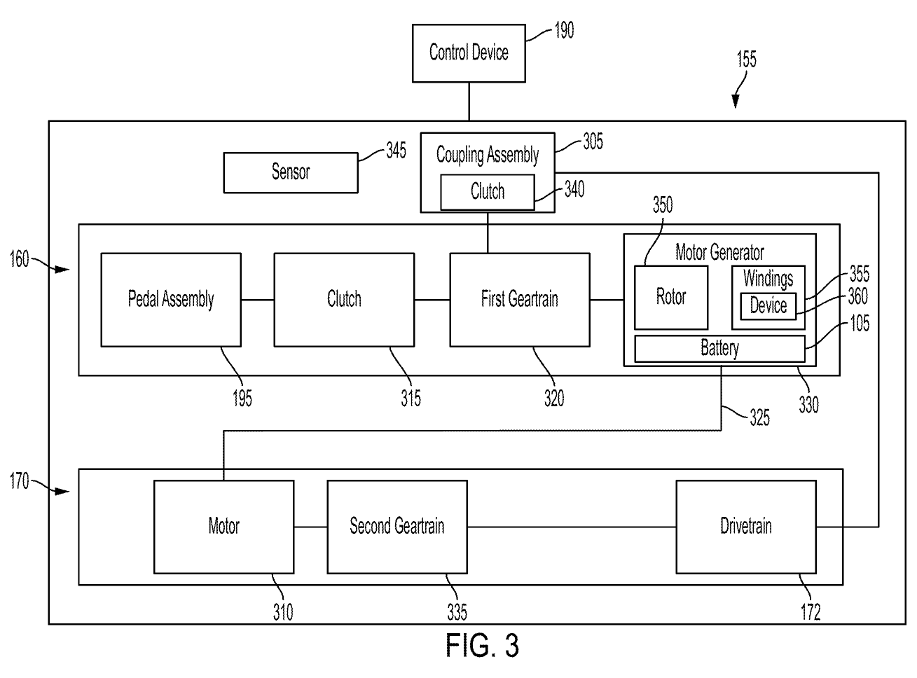

As depicted in FIGS. 1–3, among others, the vehicle 100 can include at least one drive unit 155. FIG. 3 depicts a schematic diagram of an example drive unit 155. The drive unit 155 can include at least one crank assembly 160 and at least one traction assembly 170. The crank assembly 160 can receive a mechanical force from a user (e.g., a mechanical force against a pedal). The traction assembly can include the wheel 140 and can include a geartrain or a motor to cause the wheel to rotate, as is discussed in detail below. The drive unit 155 can be a hybrid propulsion system for a bicycle 100 that can be powered by manual power (e.g., a mechanical force applied by a user to a pedal of the vehicle 100, battery power (e.g., power provided by the battery 105), or a combination thereof. For example, the drive unit 155 can allow the user to pedal the vehicle 100 to propel the vehicle 100, to use power provided by the battery 105 to propel the vehicle 100, or use a combination of the user’s manual force against the pedal and the power provided by the battery 105 to propel the vehicle 100.

The drive unit 155 can be a series or parallel system, and can be configured to modulate between both. For example, the drive unit 155 can be or include a drive unit 155 that can switch between two configurations: a series configuration and a parallel configuration. The series configuration provides a single path for power to travel to drive the vehicle 100. The series configuration can include an electrical connection between the crank assembly 160 and a traction assembly 170 of the vehicle 100. Mechanical power from the crank assembly 160 can be converted to electrical power via a motor generator 330 of the drive unit 155. The electrical power can be transferred to a traction motor 310 of the traction assembly 170 via an electrical bus 325. The traction motor 310 can convert the electrical energy back to mechanical energy to drive the bicycle 100. To switch to the parallel system, the drive unit 155 can include an actuatable coupling assembly 305. The coupling assembly 305 can be actuated automatically or manually. When engaged, the coupling assembly 305 can create a mechanical path that bypasses the motor generator 330 and the traction motor 310 such that the mechanical energy is used directly to drive or propel the vehicle 100. The coupling assembly 305 can be actuated to selectively physically couple the crank assembly 160 with the traction assembly 170 at desired times (e.g., no battery power, need additional torque, etc.). The electrical connection between the crank assembly 160 and the traction assembly 170 can remain constant, while the mechanical connection can be intermittent.

The drive unit 155 can include at least one crank assembly 160. The crank assembly 160 can include at least one pedal assembly 195. The crank assembly 160 can receive mechanical power from a user via the pedal assembly 195. For example, the pedal assembly 195 can include a pedal 196 and a shaft 197. The pedal 196 can be rotatably coupled to the shaft 197 and configured to rotate relative to the shaft 197 about a pedal axis 198. The crank assembly 160 can include at least one clutch 315. The clutch 315 can be mechanically coupled with the pedal assembly 195. The clutch 315 can be a one-way clutch or a two-way clutch, for example. The crank assembly 160 can include at least one geartrain, shown as first geartrain 320. The clutch 315 can engage a first geartrain 320. For example, the clutch 315 can selectively engage the first geartrain 320 when a user moves the pedal assembly 195 in a predetermined direction. The first geartrain 320 can include any number of gears disposed in any configuration. The first geartrain 320 can be a single speed geartrain. For example, the first geartrain 320 can have a fixed ratio. The shaft 197 of the pedal assembly 195 can be operatively coupled to the first geartrain 320. For example, rotation of the shaft 197 about a shaft axis 199 can cause the first geartrain 320 or a portion thereof to rotate. Such operative coupling of the shaft 197 with the first geartrain 320 of the crank assembly 160 can allow a user to mechanically rotate the first geartrain 320 by applying a mechanical input to the pedal 196 to rotate the shaft 197 about the shaft axis 199.

The crank assembly 160 can include the motor generator 330. The motor generator 330 can be or include a reversible electromechanical device that can convert mechanical energy into electrical energy (acting as a generator) or electrical energy into mechanical motion (acting as a motor). For example, in a series hybrid bike 100, the motor generator 330 can be connected to the pedals 196, such that it can both harvest power from pedaling and apply torque or movement back to the pedals 196 for feedback or positioning. The motor generator 330 can include a rotor 350 (connected to the pedal crankshaft), windings 355 (stationary coils of wire surrounding the rotor 350), and permanent magnets or electromagnets that establish a magnetic field within the air gap between rotor 350 and stator. The motor generator 330 can operate in a generator mode, in which mechanical torque applied by the user through the pedal assembly 195 rotates the rotor 350, causing the windings 355 to induce electrical current. Such electrical current can, for example, charge the battery 105. Electrical current can be supplied to the windings 355 (e.g., electrical current originating from the user applying a force to the crank assembly 160 via the pedal assembly 195 or power from the battery 105), generating electromagnetic forces that apply torque to the rotor 350. The rotor 350, being connected to the pedal assembly 195 (e.g., via the first geartrain 320 and the clutch 315), can use such torque to rotate or reposition the pedals 196 of the pedal assembly 195.

The crank assembly 160 can include or be operatively coupled with the battery 105. The mechanical input provided by the user via the pedal assembly 195 (e.g., via the pedal 196 of the pedal assembly 195) can be transferred to the motor generator 330 via the clutch 315 and the first geartrain 320. For example, the first geartrain 320 can be mechanically coupled with the motor generator 330. The motor generator 330 can convert the mechanical power provided via the first geartrain 320 (e.g., power provided by the user via the pedal assembly 195) into electrical power. The electrical power can be stored in the battery 105 or can be transferred to another component of the vehicle 100 (e.g., the traction motor 310) to power another component of the bicycle 100. As such, the crank assembly 160 can provide power from the pedal assembly 195 to at least one of the motor generator 330, battery 105, or the traction assembly 170. Operating the motor generator 330 as a motor can cause the first geartrain 320 to move, which can further cause the pedal assembly 195 of the crank assembly 160 (to which the first geartrain 320 is coupled) to move. In this way, the motor generator 330 can actuate the pedal assembly 195 or a portion thereof (e.g., the pedal 196, the shaft 197, or some other portion of the pedal assembly 195).

The drive unit 155 can include at least one electrical conduit, shown as electrical bus 325. The bus 325 can be an electrically conductive member that can conduct electricity to electrically couple the crank assembly 160 with traction assembly 170. The crank assembly 160 can be constantly electrically coupled with the traction assembly 170. For example, the bus 325 can create a permanent electrical connection between the crank assembly 160 and the traction assembly 170. Electrical power can transfer from the motor generator 330 or battery 105 to the traction assembly 170 via the bus 325.

The traction assembly 170 can include at least one traction motor 310. The bus 325 can electrically couple at least one of the motor generator 330 or the battery 105 with the traction motor 310 of the traction assembly 170. The electrical power created by the motor generator 330 or stored by the battery 105 can be transferred to the traction motor 310 via the bus 325. As such, the traction assembly 170 can receive the electrical power from at least one of the motor generator 330 or the battery 105 and drive the wheel 140 of the vehicle 100 using the electrical power received. For example, the traction motor 310 can convert the electrical power to mechanical power. The traction motor 310 can be mechanically coupled with another geartrain, shown as a second geartrain 335. The traction motor 310 can use the electrical power received via the bus 325 to drive the second geartrain 335.

The vehicle 100 can include at least one drivetrain 172 operatively coupling the drive unit 155 with the wheel 140 of the vehicle 100. For example, the drivetrain 172 can be coupled with or be a part of the traction assembly 170. The drivetrain 172 can mechanically couple the drive unit 155 with the wheel 140 of the bicycle 100 such that operation of the drive unit 155 can cause the wheel 140 to rotate to propel the vehicle 100, for example. The drivetrain 172 can be or include a chain or belt. The drivetrain 172 can extend between and mechanically couple the traction assembly 170, and thus the drive unit 155, with the wheel 140. For example, the drive unit 155 can be disposed away (e.g., spaced apart from) the wheel 140 with the drivetrain 172 extending between the traction assembly 170 and the wheel 140. The drivetrain 172 can transfer mechanical power from the drive unit 155 (e.g., power originating from the user applying a force to the crank assembly 160 via the pedal assembly 195 or power from the battery 105) to the wheel 140 to drive the vehicle 100. The drivetrain 172 can be mechanically coupled with the second geartrain 335 of the traction assembly 170. The drivetrain 172 can receive mechanical power from the traction motor 310 of the traction assembly 170 via the second geartrain 335. The drive unit 155 can be constantly or permanently mechanically coupled with the second geartrain 335. For example, the mechanical connection between the drivetrain 172 and the second geartrain 335 can remain constantly intact.

The drive unit 155 can include at least one coupling assembly 305. The coupling assembly 305 can selectively mechanically couple the crank assembly 160 with the traction assembly 170 (e.g., the drivetrain 172). With the crank assembly 160 mechanically coupled with the traction assembly 170, the traction assembly 170 can receive power directly from the pedal assembly 195 of the crank assembly 160. The coupling assembly 305 can be or include a clutch 340. The clutch 340 can selectively engage or disengage the crank assembly 160 and the traction assembly 170. For example, the clutch 340 can selectively mechanically couple the first geartrain 320 of the crank assembly 160 with the drivetrain 172 of traction assembly 170. The clutch 340 can be actuated manually or automatically to engage and disengage the coupling assembly 305 to selectively mechanically couple the crank assembly 160 with the traction assembly 170. For example, the coupling assembly 305 can be coupled with an electromechanical actuator. A user of the bicycle 100 can actuate the clutch 340 of the coupling assembly 305 via the electromechanical actuator. The coupling assembly 305 can be coupled with the control device 190. The control device 190 can automatically actuate the clutch 340. For example, the control device 190 can automatically actuate the clutch 340 based on riding conditions (e.g., bicycle speed, pedal speed, etc.). The control device 190 can be a part of or coupled with the drive unit 155. In other examples, the control device 190 can be associated with the vehicle 100 generally and can be communicably coupled with a control device (e.g., a controller, a printed circuit board assembly, or some other control device) that is part of the drive unit 155 specifically. In either case, the control device 190 can control or actuate the coupling assembly 305 to engage or disengage the crank assembly 160 and the traction assembly 170.

With the coupling assembly 305, the drive unit 155 can switch between a first configuration and a second configuration. In the first configuration, the crank assembly 160 can be only electrically coupled with the traction assembly 170. For example, the only connection between the crank assembly 160 and the traction assembly 170 in the first configuration is the electrical connection via the electrical bus 325. In the first configuration, the coupling assembly 305 does not form a mechanical connection between the crank assembly 160 and the traction assembly 170. In the second configuration, the crank assembly 160 can be both electrically and mechanically coupled with the traction assembly 170. For example, in the second configuration the coupling assembly 305 can create a mechanical connection between the crank assembly 160 and the traction assembly 170 with the crank assembly 160 still electrically coupled with the traction assembly 170 via the electrical bus 325. For example, the coupling assembly 305 can selectively couple the first geartrain 320 of the crank assembly 160 with the drivetrain 172 of traction assembly 170.

The first configuration can represent a series configuration of the drive unit 155 (e.g., a series hybrid system). For example, all of the power to drive the vehicle 100 can follow a single path. For example, power can initiate at the pedal 196 of the pedal assembly 195. The power can be a first mechanical power. The first mechanical power can transfer from the pedal assembly 195 to a motor generator 330. The motor generator 330 can convert the first mechanical power to electrical power. The electrical power can be transferred to the traction motor 310 of the traction assembly 170 via the bus 325. The traction motor 310 can convert the electrical power to a second mechanical power. The second mechanical power can be transferred from the traction motor 310 to the drivetrain 172. The drivetrain 172 can be coupled with a traction element (e.g., wheel 140) of the vehicle 100. The second mechanical power provided to the drivetrain 172 can cause the drivetrain 172 to drive the traction element and ultimately drive the vehicle 100.

The second configuration can represent a parallel configuration of the drive unit 155 (e.g., a parallel hybrid system). For example, the power to drive the vehicle 100 can flow through separate paths. A first path can include transferring power from the pedal assembly 195 to the motor generator 330 and the traction motor 310 before the power reaches the drivetrain 172. The second path can include transferring power from the pedal assembly 195 directly to the drivetrain 172 (e.g., without the power being converted into electrical energy). For example, the coupling assembly 305 can mechanically couple the crank assembly 160 with the drivetrain 172 such that the motor generator 330 and traction motor 310 are bypassed. In the second configuration, the first mechanical power generated by the pedal assembly 195 can be directly applied to the drivetrain 172 without first being converted to electrical power and then being converted back to a second mechanical power. In the second configuration, the power provided by the pedal assembly 195 can be transferred to the drivetrain 172 in various combinations. For example, the pedal assembly 195 can provide a first mechanical power. A first portion of the first mechanical power can be transferred directly to the drivetrain 172. A second portion of the first mechanical power can be transferred to the motor generator 330 and the traction motor 310, and converted into a second mechanical power, prior to reaching the drivetrain 172. The first portion of the first mechanical power can be greater than, less than, or equal to the second portion, and can vary according to an operation of the vehicle 100, an input of the user, or otherwise.

The motor generator 330 can actuate the pedal assembly 195. For example, the motor generator 330 move, rotate, vibrate, or otherwise actuate the pedal assembly 195 or some portion thereof (e.g., the pedal 196, the shaft 197, or some other portion thereof). Such actuation of the pedal assembly 195 can occur during various operational states of the vehicle 100. For example, the motor generator 330 can actuate the pedal assembly 195 while the traction assembly 170 is propelling the vehicle 100 (e.g., while the wheel 140 is rotating to propel the vehicle 100). The motor generator 330 can actuate pedal assembly 195 while the traction assembly 170 is not propelling the vehicle 100 (e.g., while the vehicle 100 is stopped or parked). The motor generator 330 can actuate the pedal assembly 195 of the vehicle 100 while a user is riding the vehicle 100 (e.g., while a user is positioned on the saddle 110 and the vehicle 100 is being propelled), without any user riding the vehicle 100 (e.g., when the vehicle 100 is being carried, when the vehicle 100 is parked and away from any users).

The control device 190 can control how much power is provided to the traction assembly 170 or follows which path. For example, the control device 190 can cause the coupling assembly 305 to mechanically couple the crank assembly 160 with the traction assembly 170 and route all mechanical power from the pedal 196 directly to the drivetrain 172. The control device 190 can detect when the bicycle 100 is going up an incline. With the bicycle 100 going up an incline, the control device 190 can determine how much of the mechanical power can be provided directly to the drivetrain 172 and how much to provide to the motor generator 330. The amount can be, for example, based at least partially on the vehicle speed and equivalent pedal speed. For example, with the equivalent pedal speed exceeding the vehicle speed, the control device 190 can cause the coupling assembly 305 to mechanically couple the crank assembly 160 with the traction assembly 170. The amount of power directed to each path can be based on a difference between the equivalent pedal speed and the vehicle speed. For example, the control device 190 can compare the difference to a predetermined threshold. With a difference that exceeds the threshold, the control device 190 can cause more power from the pedal 196 to go directly to the drivetrain 172. With a difference that does not exceed the threshold, the control device 190 can cause more power from the pedal 196 to go to the motor generator 330. For example, more power can be provided directly to the drivetrain 172 on a steeper incline due to the traction motor 310 and second geartrain 335 not being able to provide enough torque to drive the vehicle 100 up the incline.

Because the vehicle 100 can operate with the drive unit 155 in various configurations (e.g., a series configuration or a parallel configuration), it is understood that the vehicle 100 can be propelled without a mechanical force provided by the user to the crank assembly 160 (e.g., the pedal 196 of the pedal assembly 195). For example, the vehicle 100 can include the drive unit 155 operating in a series configuration in which power to propel the vehicle 100 comes from the battery 105 to actuate the traction motor 310, which in turn causes rotation of the wheel 140 to propel the vehicle 100. In such cases, it is not necessary for the user to apply a mechanical force to the pedal 196 of the pedal assembly 195 to propel the vehicle 100. The pedal 196 of the pedal assembly 195 is thus available to be actuated (e.g., rotated, vibrated, moved, or otherwise be actuated) without disrupting or otherwise affecting an operation to propel the vehicle 100. Likewise, the shaft 197 of the pedal assembly 195 is also available to be actuated (e.g., rotated, vibrated, moved, or otherwise actuated). For example, the motor generator 330 can actuate the pedal 196 or the shaft 197 of the pedal assembly 195 independent of any other operation of the vehicle 100 such that components of the pedal assembly 195 can be actuated while the vehicle 100 is in motion (e.g., as the wheel 140 is being rotated to propel the vehicle 100) or while the vehicle 100 is still (e.g., as the vehicle 100 is temporarily stopped at an intersection, as the vehicle 100 is parked).

The motor generator 330 can operate in a transducer mode. In the transducer mode, the motor generator 330 generates a plurality of torque values, each torque value transmitted to the pedal assembly 195 via the first geartrain 320. The transition between the plurality of torque values can produce a tactile sensation (also referred to as haptic feedback), such as vibration, which is felt by a user resting their foot on a pedal 196 of the pedal assembly 195. For example, the motor generator 330 can receive electrical energy (e.g., electrical current originating from the user applying a force to the crank assembly 160 via the pedal assembly 195 or power from the battery 105) and convert that electrical energy into a plurality of mechanical torque values applied to the pedal assembly 195 via the first geartrain 320. The motor generator 330 can receive electrical energy from the battery 105 and convert that electrical energy into a plurality of mechanical torque values applied to the pedal assembly 195 via the first geartrain 320 based on pedal assembly 195 being stationary, and therefore, in the absence of power generation by the motor generator 330 (e.g., when a user is resting their feet on the pedals 196 but not actively pedaling). For example, the control device 190 can receive data indicative of the movement of the pedal assembly 195 from sensors 345. To transmit haptic feedback to the user while the pedal assembly 195 is stationary, and thus not causing the rotor 350 of the motor generator 330 to rotate, the control device 190 can operate the battery 105 to supply electrical energy to the motor generator 330. The motor generator 330 may convert that electrical energy into a plurality of mechanical torque values applied to the pedal assembly 195 via the first geartrain 320.

The motor generator 330 can operate in the transducer mode concurrently with the generator mode or non-concurrently with the generator mode. While a user pedals the pedal assembly 195 to generate electrical current, the user can experience a base resistive torque resulting from the electrical load on the motor generator 330. The electrical load on the motor generator 330 can be varied (e.g., by the control device 190) to vary the amount of resistive torque the user experiences while pedaling. In this way, the motor generator 330 can operate in the transducer mode concurrently with the generator mode based on pedal assembly 195 moving (e.g., when a user is exerting mechanical force on the pedals 196 to move the pedals 196).

A device 360, such as a field-effect transistor or a current control device, can couple with the windings 355. Such a device 360 can be operated (e.g., by the control device 190) to vary the electrical current in the windings 355. A device 360 structured as a field-effect transistor can be or include an electrically controllable semiconductor switch having a gate, source, and drain. The field-effect transistor can be operated by the control device 190 to selectively and connect or disconnect portions of the windings 355 so as to vary the electrical current flowing through the windings 355. A device 360 structured as a current control device can be or include an electronic component or circuit, such as a transistor-based regulator, driver, or amplifier. The current control device can be operated by the control device 190 to modulate, or limit the magnitude, timing, or waveform of electrical current in the windings 355. For example, the control device 190 can operate the device 360 within the windings 355 of motor generator 330 to vary current flowing through windings, thereby varying the resistive force experienced by the user. For example, such variations alter the resistive forces acting on the rotor 350 of the motor generator 330, which is connected to the shaft 197 of the pedal 196, thereby producing corresponding changes in mechanical torque at the pedals 196. By overlaying torque changes, such as pulses, oscillations, or periodic changes in resistance, onto the base torque from power generation, the motor generator 330 can deliver tactile feedback through the pedal assembly 195 to communicate sensations such as vibration, simulated gear engagement, or terrain texture. Beneficially, the control device 190 can cause the motor generator 330 to vary the amount of resistive torque exerted on the pedal 196 without interrupting the underlying energy generation by the motor generator 330. The control device 190 can receive data indicative of the movement of the pedal assembly 195 from sensors 345. To transmit haptic feedback to the user while the pedal assembly 195 is moving, and thus causing the rotor 350 of the motor generator 330 to rotate, the control device 190 can operate one or more components of the vehicle 100 to vary the electrical load on the motor generator 330, thereby varying the amount of resistive torque the user experiences while pedaling. Such a variation in the amount of the resistive torque can produce a tactile sensation, such as vibration, pulsation, oscillation, or other actuation, by the pedal assembly 195.

The motor generator 330 can actuate the pedal assembly 195 to communicate to a user. For example, the motor generator 330 can operate in the transducer mode to actuate the pedal assembly 195 to provide haptic feedback to the user of the vehicle 100. For example, the motor generator 330 can vibrate the pedal 196 of the pedal assembly 195 to provide haptic feedback to the user of the vehicle 100. In addition to or as an alternative to the motor generator 330 providing the haptic feedback, the vehicle 100 can include a generator, a haptic generator, or a an actuator within the pedal assembly 195 (e.g., a piezo motor, an eccentric motor, among others) to that actuates within the pedal assembly 195 to vibrate the pedal 196 of the pedal assembly 195, thereby providing haptic feedback to the user.

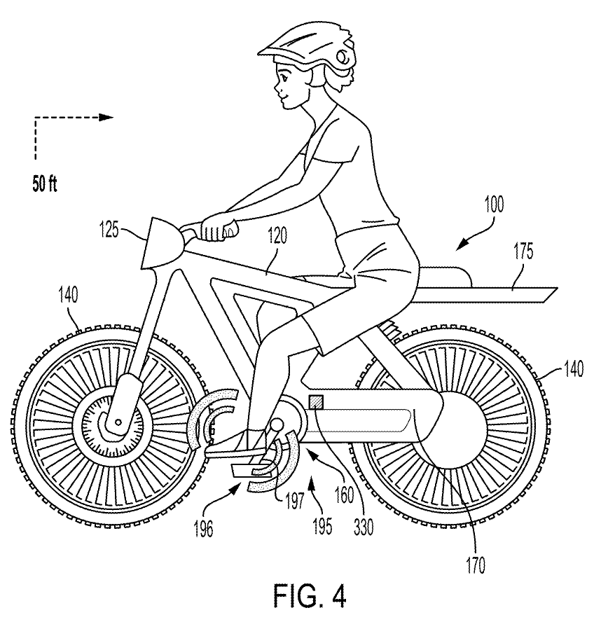

For example, as depicted in FIG. 4, among others, the motor generator 330 can operate in the transducer mode to cause the pedal 196 of the pedal assembly 195 to vibrate, based on a signal from the control device 190, in order to communicate some information to the user as the user is riding the vehicle 100. For example, the motor generator 330 can operate in the transducer mode to cause the pedal 196 of the pedal assembly 195 to vibrate or otherwise actuate to communicate information regarding navigation of the vehicle 100, such as to communicate that a turn is upcoming, that the user has reached a destination (e.g., a final or intermediate destination), or some other navigation-related information. Such navigation information can be based on an active or planned navigation operation of the user, where such navigation operation can be a navigation operation on a third-party navigation application (e.g., a mobile application on the user’s mobile device), a navigation on a user interface of the vehicle 100 (e.g., a user interface operatively coupled with the control device 190), or some other navigation operation. For example, the navigation-related information can be or include a desired route of travel that includes one or more turns having an associated turning direction (e.g., left turn, right turn). The motor generator 330 can operate to cause one pedal 196 of the pedal assembly 195 to vibrate based on the turning direction of an upcoming turn on the route. For example, the motor generator 330 can provide haptic feedback via the left pedal 196 based on an upcoming left turn, and can provide haptic feedback via the right pedal 196 based on an upcoming right turn (e.g., the vehicle 100 is within some predefined distance of the upcoming turn). The motor generator 330 can operate in the transducer mode to cause the pedal 196 of the pedal assembly 195 to vibrate or otherwise actuate to communicate an obstacle that is upcoming and is potentially within the path of the vehicle 100, such as a road closure, a physical obstacle blocking the path of the vehicle 100, or some other obstacle. The motor generator 330 can operate in the transducer mode to cause the pedal 196 of the pedal assembly 195 to vibrate or otherwise actuate to communicate that a speed of the vehicle 100 exceeds some threshold (e.g., a speed limit, a user-defined threshold speed, or some other threshold) or that the vehicle 100 is about to depart from a lane or path (e.g., a lane-departure warning).

The motor generator 330 can operate in the transducer mode to cause the pedal 196 of the pedal assembly 195 to vibrate or otherwise actuate to communicate information regarding a status of the vehicle 100, such as a warning that a state of charge of the battery 105 is less than a predefined threshold, a warning that a tire pressure is below some threshold, a warning of some malfunction of the vehicle 100 requiring the user’s attention, or some other information regarding a status of the vehicle 100. The motor generator 330 can operate in the transducer to cause the pedal 196 of the pedal assembly 195 to vibrate or otherwise actuate based on user input initiating a change in gear or a change in pedal resistance. For example, if a user makes an input to change from a first gear to a second gear, the control device 190 can cause the motor generator 330 to modulate the torque applied to the pedal 196 in a manner that emulates the tactile feel of a mechanical gear change. The motor generator 330 can operate in the transducer mode to cause the pedal 196 of the pedal assembly 195 to vibrate or otherwise actuate to communicate information from an external data source or device. For example, the motor generator 330 can cause the pedal 196 of the pedal assembly 195 to vibrate or otherwise actuate to communicate information regarding weather as provided by a third-party weather service, to provide a notification associated with a user’s mobile device (e.g., a notification that a text message was received by the user’s mobile device or that the user is receiving an incoming call).

The motor generator 330 can operate in the transducer mode to cause one of a first pedal 196 or a second pedal 196 of the pedal assembly 195 to vibrate or otherwise actuate based on a turn signal activation. For example, a user may activate a turn signal by operating an input device. The turn signal may have an associated direction (e.g., a right turn signal, a left turn signal). The control device 190 can receive such a user input and operate the motor generator 330 in the transducer mode to vibrate or otherwise actuate one of the first pedal 196 or the second pedal 196 based on the direction associated with the turn signal. For example, the motor generator 330 can operate in the transducer mode to cause the first pedal 196 to vibrate based on a user activating a right turn signal and may cause the second pedal 196 to vibrate based on a user activating a left turn signal. The vibration or actuation signal can originate from the control device 190, from an external mobile device (e.g., a mobile phone or other mobile device), or from a combination of both. For example, a mobile device may receive a notification such as a text message and transmit a corresponding signal to the vehicle 100, which may then actuate a haptic response via the motor generator 330 or modify a haptic response generated by the motor generator 330 based on an input from the mobile device.

The vehicle 100 can include at least one sensor 345, as shown in FIG. 3. The number, placement, and type of sensors 345 included in the vehicle 100 are shown for example purposes only. That is, in other configurations, the number, placement, and type of sensors 345 may differ. The sensors 345 may be real or virtual (i.e., a non-physical sensor that is structured as program logic in the control device 190 that makes various estimations or determinations). For example, a sensor 345 can be structured as an inertial measurement unit (IMU), a suspension position sensor, or some other sensor configured to detect the noise level (e.g., vibration or roughness) of the surface on which the vehicle 100 is traveling. For example, an asphalt road may have a first noise level (e.g., amplitude, frequency) and a cobblestone road may have a second, larger, noise level (e.g., amplitude, frequency). The control device 190 can adjust the haptic feedback generated by the motor generator 330 based on the detected noise level. For example, the haptic feedback can be varied so that the user can sense a desired signal even when traveling on a rough road. For example, while the vehicle 100 travels on the road having the second, larger, noise level, the control device 190 can cause the motor generator 330 to transmit a plurality of torque values having a greater difference from one another, to the pedal assembly 195. Increasing the difference between torque values (e.g., increasing the amplitude of a torque waveform) can increase the perceived intensity of the haptic signal to the user. Certain road conditions may cause the suspension to dampen some vibration frequencies, while others may still be transferred through the pedals 196 of the pedal assembly 195 to the user Accordingly, the control device 190 can define a transfer function between the vibration characteristics of the road surface and the sensation perceived by the user via the pedals. This transfer function can be applied to modify or filter the haptic signal generated by the motor generator 330 so that the sensation remains consistent and regardless of underlying road surface variations.

The noise level detected by the sensor 345 can indicate a vibration characteristic of the road. Vibration characteristics can refer to the tactile profile or feel associated with vibration from a surface on which the vehicle is traveling. The control device 190 can cause the motor generator 330 to vary the torque experienced by the user operating the pedal 196 of the pedal assembly 195 based on the data indicative of the noise level. For example, rapid oscillations in torque can create vibrations that emulate the feel of an asphalt road and short pulses can emulate surface irregularities like cobblestones.

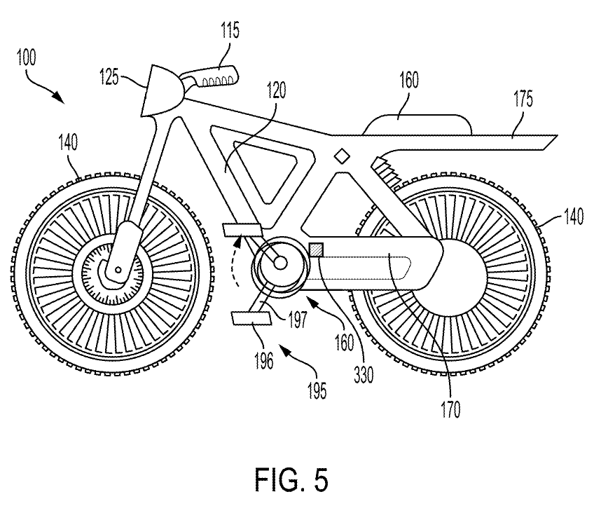

The motor generator 330 can cause the shaft 197 of the pedal assembly 195 to rotate or otherwise actuate. For example, as depicted in FIG. 5, among others, the motor generator 330 can cause the shaft 197 of the pedal assembly 195 to rotate or otherwise actuate while the vehicle 100 is not moving, such as when the user is riding the vehicle 100 but when the vehicle 100 is stopped (e.g., when the vehicle 100 is temporarily stopped during use, before the user begins to propel the vehicle 100, or after the user brings the vehicle 100 to a stop). The motor generator 330 can cause the shaft 197 of the pedal assembly 195 to rotate or otherwise actuate to change an angular position of the shaft 197 and the pedal 196 coupled with the shaft 197. The motor generator 330 can cause the shaft 197 of the pedal assembly 195 to rotate to bring the shaft 197 and the pedal 196 into an angular position that can more readily receive a mechanical force from the user. For example, the motor generator 330 can cause the shaft 197 of the pedal assembly 195 to rotate to move the pedal 196 to an angular position that can receive a downward, pushing mechanical force from the user (e.g., an angular position between with some horizontally-forward directional component, rather than a vertical or horizontally-rearward directional component) from an angular position that may not readily receive a pushing mechanical force from the user (e.g., an angular position between with a vertical or horizontally-rearward directional component, rather than a horizontally-forward directional component). For example, the motor generator 330 can rotate the shaft 197 of the pedal assembly 195 from a stopping position (e.g., a position in which the shaft 197 resides at the end of a riding session as the vehicle 100 comes to a stop) to a starting position (e.g., a home position of the shaft 197 that positions the pedal 196 to receive a mechanical force from the user). In this way, the motor generator 330 can move the pedal 196 of the pedal assembly 195 to a position in which the user can immediately apply a productive force to mechanically propel the vehicle 100 without requiring the user to manually rotate the pedal 196 to such a position.

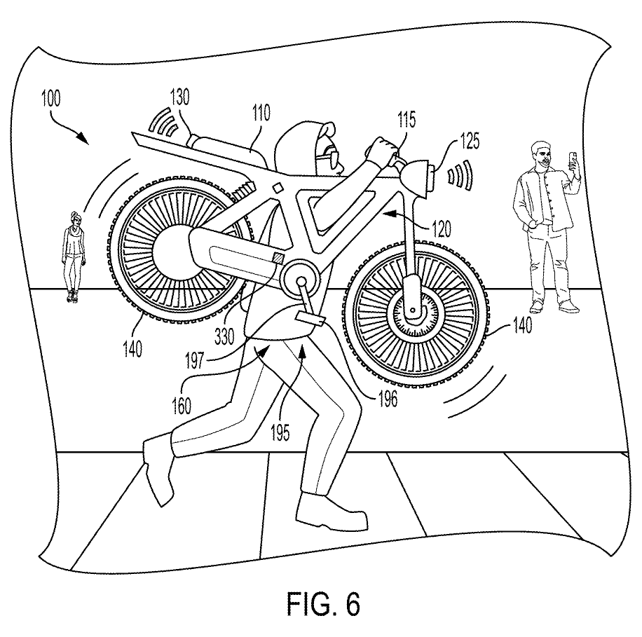

In another example, the motor generator 330 can cause the shaft 197 of the pedal assembly 195 to spin or rotate for some period of time. For example, as depicted in FIG. 6, among others, the motor generator 330 can cause the shaft 197 of the pedal assembly 195 to rotate based on a determination that the vehicle 100 is being stolen, where such rotation of the pedal 196 can make it difficult for a wrong-doer who is attempting to steal the vehicle 100 to effectively pick up the vehicle 100. For example, the motor generator 330 apply torque to the rotor 350, thereby causing the shaft 197 of the pedal assembly 195 to rotate. For example, the motor generator 330 can lock or resist movement of the pedal assembly 195 to prevent an unauthorized user from successfully applying a mechanical force to the pedal 196 to propel the vehicle 100.

The motor generator 330 can operate in the transducer mode to actuate the pedal assembly 195 or some component thereof according to one or more user preferences. For example, the user can specify user preferences via a user interface of the control device 190, an application (e.g., a mobile application on a mobile device of the user, a web-based application, or some other application) communicably coupled with the control device 190, or other interface coupled with the control device 190. The user preferences can dictate the operation of the motor generator 330 to actuate the pedal assembly 195. For example, the user can specify that the motor generator 330 should move the pedal 196 to a desired angular position whenever the vehicle 100 temporarily comes to a stop during operation (e.g., as the user is riding to a destination). In another example, the user can specify that the motor generator 330 should provide navigation-related haptic feedback, but not weather-related haptic feedback. In embodiments where the motor generator 330 vibrates the pedal 196, the user can specify a vibratory pattern (e.g., regular or intermittent pulses, sequenced pulses, or some other vibratory pattern), an intensity of the vibration, or a duration of the vibration. Such vibratory preferences can vary according to the information communicated by the haptic feedback. For example, navigation-related haptic feedback can cause the motor generator 330 to move the pedal 196 in one manner, while obstacle- or hazard-related haptic feedback can cause the motor generator 330 to move the pedal 196 in a different manner.

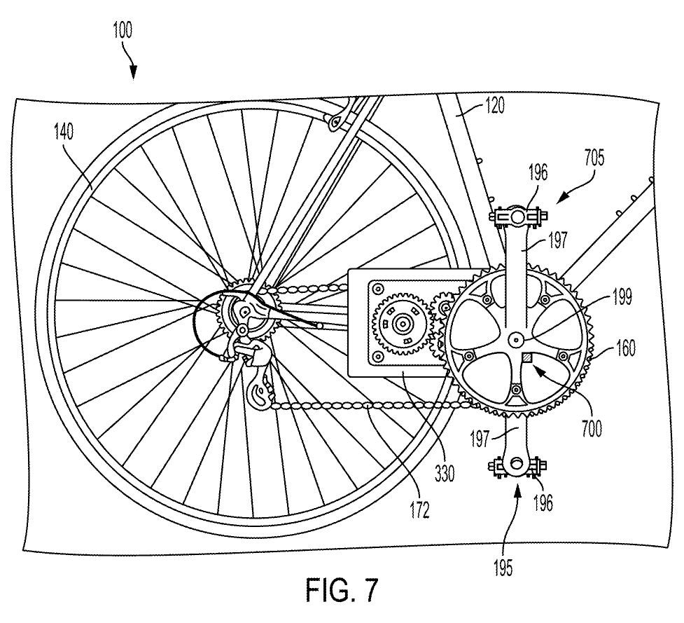

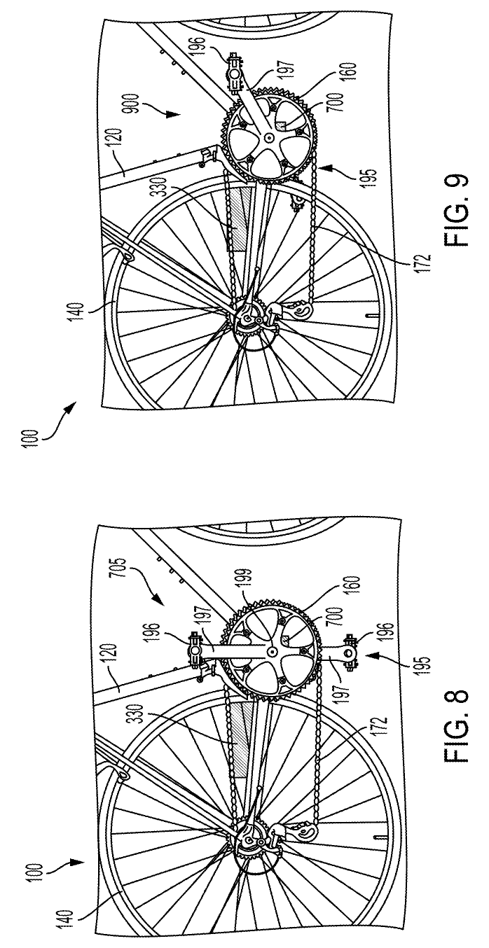

FIGS. 7–11, among others depict the vehicle 100. The vehicle 100 can include at least one sensor 700. The sensor 700 can be a position sensor. For example, sensor 700 can determine a current position of the pedal assembly 195. For example, the sensor 700 can determine an angular position of the shaft 197 of the pedal assembly 195 about the shaft axis 199. The position sensor 700 can be an encoder (e.g., rotary encoder, an optical encoder, an inductive encoder, a capacitive encoder, a hall effect sensor, a motor generator 330 rotor 350 sensor) or some other type of rotational position sensor. For example, the sensor 700 can be a magnetic sensor including a magnet coupled to the crank assembly 160 of the vehicle 100. The sensor 700 of the vehicle 100 can be a motion sensor. For example, the sensor 700 can be a motion sensor, accelerometer, inertial measurement unit, or some other sensor that can detect whether the vehicle 100 or a component thereof (e.g., the pedal assembly 195) is in motion and to what extent (e.g., what direction, what velocity, what acceleration) the vehicle 100 or the component thereof is in motion. The motion sensor can be configured to determine a state of the vehicle 100 (e.g., whether in motion, whether at a temporary standstill during operation, or whether parked and thus not engaged in a riding operation). The sensor 700 can be a torque sensor. For example, the torque sensor can determine an amount of torque or force applied by a user (e.g., a rider) to the pedal assembly 195. The torque sensor can determine an amount of force applied by the user against the pedal 196 to rotate the shaft 197 of the pedal assembly 195 and propel the vehicle 100. The torque sensor can, for example, determine whether or not a user’s foot is on the pedal 196.

The sensor 700 can include an optical sensor to optically detect a position of the pedal 196 or the shaft 197, a position of the user (e.g., the user’s foot) relative to the pedal 196 or the shaft 197, or some other sensor. The sensor 700 can be a power meter configured to determine an optimum angle for the pedal 196 or the shaft 197 of the pedal assembly 195 based on a user’s riding preference or previously applied torque, where the optimum angle would be configured to allow the user to apply a torque and efficiently propel the vehicle 100 from a standstill, for example. In some examples, the vehicle 100 can include multiple sensors 700, such as a position sensor, a motion sensor, a torque sensor, or some other sensor.

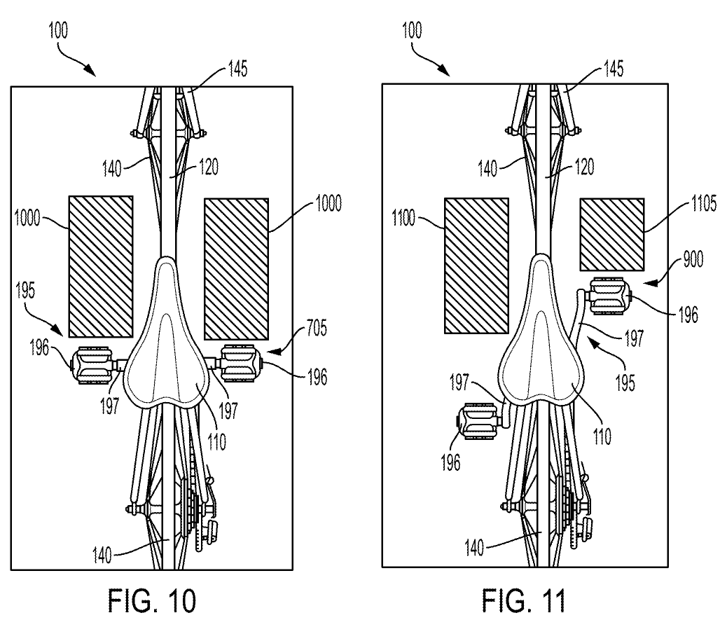

FIGS. 7–11, among others, depict the pedal assembly 195 of the vehicle 100 in various orientations. For example, FIGS. 7, 8 and 10 depict the pedal assembly 195 of the vehicle 100 with the pedal 196 in an ingress/egress position 705 characterized by the vertical orientation of the shaft 197 to position the pedal 196 either at a twelve o’clock position or a six o’clock position. With the pedal 196 in the ingress/egress position 705, a space forward of the pedal 196 can be maximized on both sides of the vehicle 100. For example, as shown in FIG. 10, a space 1000 is present on both sides of the frame 120 of the vehicle 100, where the space 1000 is optimized or is suitable for ingress or egress of a user relative to the vehicle 100. In FIGS. 9 and 11, the pedal assembly 195 is shown with the pedal 196 in a launch position 900. The launch position 900 is characterized by the positioning of one pedal 196 on one side of the vehicle 100 approximately 45–90° forward of top-dead-center (e.g., the twelve o’clock position). In such an orientation, a user’s foot (e.g., a user’s dominant foot) can apply force to the pedal 196, where that force will efficiently translate into motion of the pedal 196 in a downward direction and rotation of the crank assembly 160 to propel the vehicle 100. Application of a user’s downward force to the pedal 196 with the pedal 196 in the launch position 900 is more efficient than application of a force of similar magnitude with the pedal 196 in the ingress/egress position 705 because substantially no forward component of the force is required to effectuate rotation of the crank assembly 160. As shown in FIG. 11, the launch position 900 of the pedal assembly 195 creates a space 1100 on one side of the pedal assembly 195 and a space 1105 on the opposite side of the pedal assembly 195, where the space 1105 is not optimized for ingress/egress because the space 1105 is smaller than the space 1000 depicted in FIG. 10, for example. However, because the launch position 900 is configured to optimize for launch of the vehicle 100 from a stop or standstill, the reduced size of space 1105 relative to the space 1000 is acceptable.

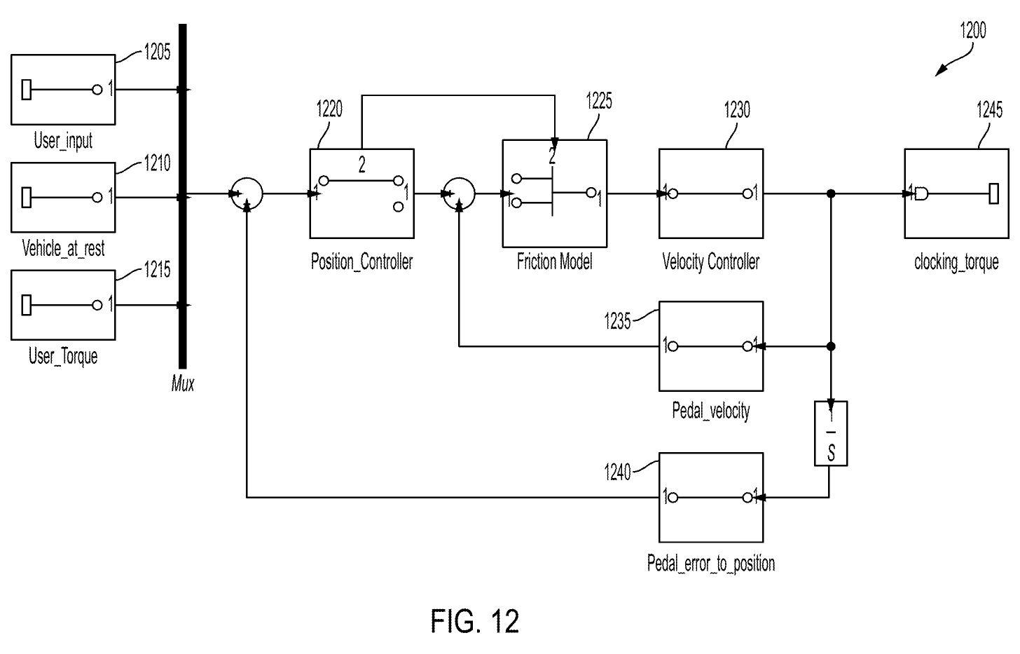

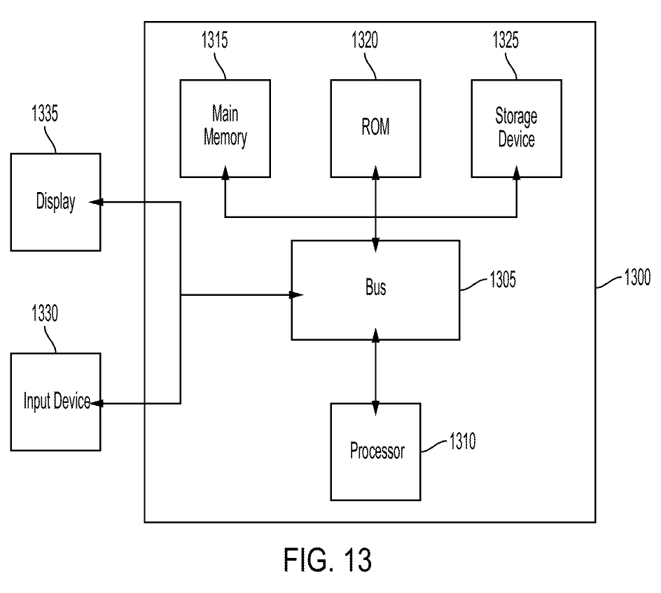

The motor generator 330 can move the pedal 196 of the pedal assembly 195 into a desired position or orientation, such as the ingress/egress position 705 or the launch position 900. For example, the vehicle 100 can include the control device 190 or the computing system 1300 depicted in FIG. 13 to carry out an operation to actuate the pedal assembly 195 via the motor generator 330 to move the pedal 196 into a desired position or orientation, such as the ingress/egress position 705 or the launch position 900. FIG. 12 depicts a flow chart of a control operation 1200. The control operation 1200 can manage a pedal clocking operation for the bicycle 100 or some other pedal-equipped vehicle. For example, the control operation 1200 can include processing one or more input conditions, such as a user input 1205 provided by a rider, an input from a stop/standstill sensor 1210, an input from a torque sensor 1215, or any other suitable signal or condition. For example, the control operation 1200 can begin when or can include a condition that the vehicle 100 be at a stop or standstill, as can be determined by an accelerometer on the vehicle 100. In other examples, the user can provide a signal via the control device 190 (e.g., provide an input via a button or screen) to request performance of some pedal clocking operation. In some examples, when a clocking request is present, the vehicle 100 is at rest, and the rider is not exerting prohibitive torque on the pedal 196 of the pedal assembly 195. In some examples, the vehicle 100 can include the torque sensor 1215 that can determine an amount of torque applied by the user and prohibit a pedal clocking operation if the amount of torque exceeds a threshold value. In yet other example, the vehicle 100 can perform the operation 1200 after first receiving a request for a pedal clocking operation (e.g., a user input via the control device 190) and then verifying that one or more other conditions are satisfied (e.g., no torque presently applied by a user to the pedal 196 as determined by torque sensor 1215 or vehicle 100 at a standstill as determined by stop/standstill sensor 1210). If requisite conditions are satisfied, the vehicle 100 can proceed with the control operation 1200.

For example, during the control operation 1200, a pedal error position block 1240 can determine a difference between a desired position of the pedal 196 (e.g., a desired angular position of the shaft 197 or a desired crank angle) and a current position of the pedal 196, as determined by the sensor 700. The control device 190 or the computing system 1300 can determine that a desired position of the pedal 196 is about 60–90° past (e.g., forward of) top-dead-center on a side of the vehicle 100 associated with a user’s dominant foot in a launch scenario (e.g., a scenario in which the user wishes to begin riding from a standstill, for example). In other examples, a desired position of the pedal 196 can be less than 60° past top-dead-center or greater than 90° past top-dead-center. In an ingress/egress scenario (e.g., a scenario in which the user is getting onto (e.g., mounting, entering) or getting off of (e.g., dismounting, exiting) the vehicle 100), a desired position of the pedal 196 can be approximately top-dead-center (e.g., less than 15° degrees from top-dead-center in either a forward or reverse direction). In other examples, the vehicle 100 can be in some other scenario that is associated with some other desired pedal position. For example, the vehicle 100 can be in a race position or a comfort position in which the desired pedal position is optimized for a rapid launch or user force exertion, respectively. The desired pedal position can be determined by sensor inputs (e.g., the sensor 700 or some other sensor to record data associated with a user’s operation of the vehicle 100 over some time period) or based on an input provided by the user (e.g., the user input 1205). In various examples, the user input 1205, the stop/standstill sensor 1210, and the torque sensor 1215 can, individually or in some combination, determine whether the vehicle 100 is in a launch scenario, in an ingress/egress scenario, or in some other scenario.

The pedal error position block 1240 can determine a difference between the current pedal position and the desired pedal position, where the desired pedal position depends on the scenario (e.g., a launch scenario or an ingress/egress scenario). Specifically, the control operation 1200 and the computing system 1300 can determine a current position of the pedal 196 using a position sensor (e.g., the sensor 700). The resulting error or difference between a current pedal position as determined by a position sensor 700 and the determined desired position can be forwarded to a position controller block 1220. The position controller block 1220 can be a circuit or other computing device that can execute a proportional-integral-derivative (PID) or other suitable closed-loop algorithm to translate the error into a provisional torque demand, for example. The position controller block 1220 can receive a real-time velocity limit supplied by a velocity controller block 1230. The velocity controller block 1230 can be a circuit or other computing device that can generate a velocity limit by referencing a friction model 1225. The friction model 1225 can be implemented, for example, as a look-up table, an adaptive observer, or another modeling technique. The velocity controller block 1230 can further monitor an actual pedal velocity, represented by pedal velocity block 1235, which can be determined by the sensor 700 or some other sensor adapted to determine a velocity of the pedal 196 (e.g., an instantaneous velocity, an average velocity over some time). The friction model 1225 can estimate available drivetrain drag or friction associated with deceleration of the crank assembly 160 or the pedal assembly 195. The control operation 1200 can include the velocity controller block 1230 to limit or bound the maximum acceleration and velocity with which the pedal assembly 195 or the crank assembly 160 is advanced in moving the pedal assembly 195 from a current position to the desired position. For example, the position controller block 1220 can combine this velocity limit determined by the velocity controller block 1230 with a position error determined by the pedal error position block 1240 to determine and transmit a torque command.

The torque command, determined by the velocity controller block 1230, can be provided to a clocking torque block 1245. The clocking torque block 1245 can be a circuit or other computing device that can be communicably coupled to the motor generator 330 and can cause the motor generator 330 to actuate the pedal assembly 195 (e.g., to move the pedal 196 to the desired position). As the motor generator 330 applies torque, the position and velocity feedback signals can continuously update blocks 1240 and 1235 until the pedal error position block 1240 indicates that a difference between a current position of the pedal 196 and the desired position of the pedal 196 falls within some predetermined threshold or tolerance range. Once the pedal 196 reaches its desired position, the position controller block 1220 can command the clocking torque block 1245 to hold the crank assembly 160 and the pedal assembly 195 at the desired position by applying low holding torque, an electromagnetic brake, or another retention mechanism, for example, until normal pedaling resumes or a new clocking request is issued.

The control operation 1200 described herein can be adapted to a broad range of platforms, involving both two-wheeled bicycles 100 or other pedal-operated vehicles 100 having any number of wheels 140 (e.g., four wheels, three wheels, or some other number of wheels). For instance, the user input 1205 can be replaced by an automatic trigger generated from a GPS signal (e.g., GPS signal associated with a traffic light database), the stop/standstill sensor 1210 can include data inferred solely from inertial-measurement-unit data (e.g., data from the sensor 700) or from data recorded by multiple sensors, and the torque sensor 1215 can be or include an optical foot-presence detector. Likewise, the friction model 1225 can be a constant offset or can be a neural-network estimator.

FIG. 13 is a block diagram illustrating an architecture for a computer system 1300 that can be employed to implement elements of the systems and methods described and illustrated herein, including, for example, the vehicle 100, among others. For example, the control device 190 or some other control device of the vehicle 100 can be or include the computing system 1300, can include at least one bus 1305 or other communication component for communicating information, and at least one processor 1310 or processing circuit coupled to the bus 1305 for processing information. The computing system 1300 can also include one or more processors 1310 or processing circuits coupled to the bus 1305 for processing information. The computing system 1300 also includes at least one main memory 1315, such as a random access memory (RAM) or other dynamic storage device, coupled to the bus 1305 for storing information, and instructions to be executed by the processor 1310. The main memory 1315 can be used for storing information during execution of instructions by the processor 1310. The computing system 1300 may further include at least one read only memory (ROM) 1320 or other static storage device coupled to the bus 1305 for storing static information and instructions for the processor 1310. A storage device 1325, such as a solid state device, magnetic disk or optical disk, can be coupled to the bus 1305 to persistently store information and instructions.

The computing system 1300 may be coupled via the bus 1305 to a display 1335, such as a liquid crystal display, or active matrix display, for displaying information to a user such as a rider of the vehicle 100 or other end user. An input device 1330, such as a keyboard or voice interface, may be coupled to the bus 1305 for communicating information and commands to the processor 1310. The input device 1330 can include a touch screen display 1335. The input device 1330 can also include a cursor control, such as a mouse, a trackball, or cursor direction keys, for communicating direction information and command selections to the processor 1310, and for controlling cursor movement on the display 1335.

The processes, systems and methods described herein can be implemented by the computing system 1300 in response to the processor 1310 executing an arrangement of instructions contained in main memory 1315. Such instructions can be read into main memory 1315 from another computer-readable medium, such as the storage device 1325. Execution of the arrangement of instructions contained in main memory 1315 causes the computing system 1300 to perform the illustrative processes described herein. One or more processors in a multi-processing arrangement may also be employed to execute the instructions contained in main memory 1315. Hard-wired circuitry can be used in place of or in combination with software instructions together with the systems and methods described herein. Systems and methods described herein are not limited to any specific combination of hardware circuitry and software.

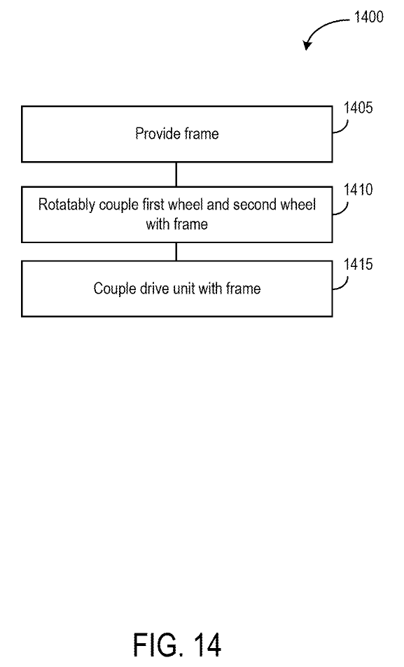

FIG. 14 is a flow diagram of a method 1400 of manufacturing the vehicle 100. The method 1400 can include at least one act of providing the frame 120 (e.g., act 1405). Providing the frame 120 can include assembling, manufacturing, shipping, or otherwise providing the frame 120. The method 1400 can include at least one act of rotatably coupling the first wheel 140 and the second wheel 140 with the frame 120 (e.g., act 1410). At least one of the first wheel 140 or the second wheel 140 may be coupled with the drivetrain 172 of the vehicle 100, such that the drivetrain 172 operates to rotate at least one of the first wheel 140 or the second wheel 140. For example, the drivetrain 172 of the vehicle 100 can be a chain, gear, belt, or some combination thereof that couples the drive unit 155 with the rear wheel 140 of the vehicle 100 such that the drive unit 155 can rotate or drive the rear wheel 140.

The method 1400 can include at least one act of coupling the drive unit 155 with the frame 120 (e.g., act 1415). The drive unit 155 can include the crank assembly 160 and the traction assembly 170. For example, the drive unit 155 can include the pedal assembly 195, the first geartrain 320, and the motor generator 330. The motor generator 330 can couple with the pedal assembly 195 via the first geartrain 320. For example, a rotor 350 of the motor generator 330 can couple with the first geartrain 320, such that the motor generator 330 exerts torque on the pedal assembly 195 via the first geartrain 320. The motor generator 330 can generate and transmit a plurality of torque values to the pedal 196 to produce a tactile sensation by the pedal 196 of the pedal assembly 195.

For example, the motor generator 330 can operate in a transducer mode to produce a tactile sensation by the pedal 196 of the pedal assembly 195 to provide haptic feedback to a user of the vehicle 100. In the transducer mode, the motor generator 330 generates a plurality of torque values, each torque value transmitted to the pedal assembly 195 via the first geartrain 320. The transition between the plurality of torque values can produce a tactile sensation (also referred to as haptic feedback), such as vibration, which is felt by a user resting their foot on a pedal 196 of the pedal assembly 195.

The motor generator 330 can operate in the transducer mode concurrently with the generator mode or non-concurrently with the generator mode. While a user pedals the pedal assembly 195 to generate electrical current, the user can experience a base resistive torque resulting from the electrical load on the motor generator 330. The electrical load on the motor generator 330 can be varied (e.g., by the control device 190) to vary the amount of resistive torque the user experiences while pedaling. For example, the control device 190 can operate the motor generator 330 to control the amount of electrical current flowing out the windings 355 to vary the electrical load on the motor generator 330. Such variations alter the electromagnetic forces acting on the rotor 350 of the motor generator 330, which is connected to the shaft 197 of the pedal 196, thereby producing corresponding changes in mechanical torque at the pedals 196. By overlaying torque changes, such as pulses, oscillations, or periodic changes in resistance, onto the base torque from power generation, the motor generator 330 can deliver tactile feedback through the pedal assembly 195 to communicate sensations such as vibration, simulated gear engagement, or terrain texture. The motor generator 330 can vary the amount of resistive torque exerted on the pedal 196 without interrupting the underlying energy generation by the motor generator 330.

The method 1400 can include at least one act of coupling the traction motor 310 with the second geartrain 335. For example, the drivetrain 172 can be mechanically coupled with the second geartrain 335 of the traction assembly 170. The drivetrain 172 can receive mechanical power from the traction motor 310 of the traction assembly 170 via the second geartrain 335. The drivetrain 172 can be constantly or permanently mechanically coupled with the second geartrain 335. For example, the mechanical connection between the drivetrain 172 and the second geartrain 335 can remain constantly intact. The electrical power created by the motor generator 330 or stored by the battery 105 can be transferred to the traction motor 310 via the bus 325. As such, the traction assembly 170 can receive the electrical power from at least one of the motor generator 330 or the battery 105 and drive the wheel 140 of the vehicle 100 using the electrical power received. For example, the traction motor 310 can convert the electrical power to mechanical power. The traction motor 310 can be mechanically coupled with another geartrain, shown as a second geartrain 335. The traction motor 310 can use the electrical power received via the bus 325 to drive the second geartrain 335.

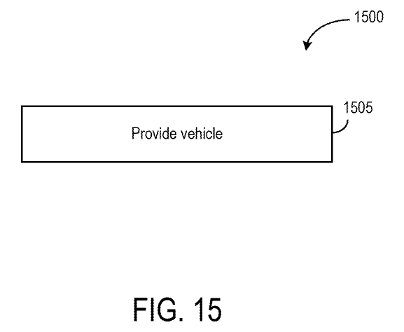

FIG. 15 is a flow diagram of a method 1500 of providing the vehicle 100. The method 1500 can include at least one act of providing the vehicle 100 (e.g., act 1505). For example, providing the vehicle 100 can include providing (e.g., assembling or manufacturing, in whole or in part) a frame 120, a first wheel 140, a second wheel 140, a drive unit 155, and a traction motor 310. The first wheel 140 and the second wheel 140 can rotatably couple with the frame 120. For example, the first wheel 140 and the second wheel 140 can rotatably couple with the frame 120 by one or more pin connections. The drive unit 155 can couple with the frame 120. For example, the drive unit 155 can couple with the frame 120 by one or more fasteners, frame members, or by welding, among other coupling devices. The drive unit 155 can include a first geartrain 320, a second geartrain 335, a pedal assembly 195 configured to receive mechanical input from a user, and a motor generator 330 coupled with the pedal assembly 195 via the first geartrain 320. For example, a rotor 350 of the motor generator 330 can couple with the first geartrain 320, such that rotation of the rotor 350 of the motor generator 330 causes rotation of the pedal assembly 195 via the first geartrain 320. The motor generator 330 can operate in a plurality of modes. For example, electrical current (e.g., current originating from the user applying a force to the crank assembly 160 via the pedal assembly 195 or power from the battery 105) can be supplied to the windings 355 of the motor generator 330, generating electromagnetic forces that apply torque to the rotor 350 to rotate or otherwise move the pedal assembly 195. The motor generator 330 can operate in a generator mode in which mechanical torque applied by the user through the pedal assembly 195 rotates the rotor 350, causing the windings 355 within the motor generator 330 and induce electrical current. The motor generator 330 can operate in a transducer mode to generate a plurality of torque values. Each of the plurality of torque values can be transmitted to the pedal assembly 195 via the first geartrain 320. The transition between the plurality of torque values can produce a tactile sensation/haptic feedback by the pedal assembly 195.

The motor generator 330 can operate in the transducer mode concurrently with the generator mode or non-concurrently with the generator mode. While a user pedals the pedal assembly 195 to generate electrical current, the user can experience a base resistive torque resulting from the electrical load on the motor generator 330. The electrical load on the motor generator 330 can be varied (e.g., by the control device 190) to vary the amount of resistive torque the user experiences while pedaling. The motor generator 330 can operate in the transducer mode concurrently with the generator mode based on pedal assembly 195 moving (e.g., when a user is exerting mechanical force on the pedals 196 to move the pedals).

At least one aspect is directed to a vehicle. The vehicle can include a frame. The vehicle can include a first wheel and a second wheel rotatably coupled with the frame. The vehicle can include a drive unit coupled with the frame. The drive unit can include a pedal assembly configured to receive mechanical input from a user. The drive unit can include a motor generator coupled with the pedal assembly. The motor generator can include a rotor and windings. The motor generator can operate in a generator mode to generate electrical current based on the mechanical input applied by the user to the pedal assembly. The generator mode can vary an amount of resistive torque exerted on the pedal assembly and an amount of power generated per rotation of the rotor. For example, the vehicle can include a current control device or a field-effect transistor coupled with the windings of the motor generator. The current control device or the field-effect transistor can vary the electrical current flowing through the windings to vary the resistive torque exerted on the pedal assembly. The motor generator can operate in a transducer mode to generate a plurality of torque values, each transmitted to the pedal assembly. A transition between the plurality of torque values can produce a tactile sensation by the pedal assembly. The generator mode and the transducer mode can be operable concurrently and non-concurrently.

The plurality of torque values can be a first plurality of torque values and the tactile sensation can be a first tactile sensation having a first intensity. The vehicle can include a control device. The control device can detect, based on data from a sensor, a first surface on which the vehicle is traveling, the first surface having a first noise level. The control device can determine the first plurality of torque values based on the first noise level. The control device can detect, based on data from the sensor, a second surface on which the vehicle is traveling. The second surface can have a second noise level greater than the first noise level. The control device can determine a second plurality of torque values that can produce a second tactile sensation having a second intensity based on the second noise level. The second intensity can be greater than the first intensity. The control device can cause the motor generator to operate in the transducer mode to generate the second plurality of torque values based on the detection of the second surface.

At least one aspect is directed to a vehicle. The vehicle can include a frame. The vehicle can include a first wheel and a second wheel rotatably coupled with the frame. The vehicle can include a drive unit coupled with the frame. The drive unit can include a pedal assembly configured to receive mechanical input from a user. The pedal assembly can include a pedal and a shaft, the pedal rotatably coupled with the shaft, the pedal configured to receive the mechanical input from the user. The drive unit can include a motor generator coupled with the pedal assembly. The motor generator can include a rotor and windings. The motor generator can operate in a generator mode to generate electrical current based on the mechanical input applied by the user to the pedal assembly. The generator mode can vary an amount of resistive torque exerted on the pedal assembly and an amount of power generated per rotation of the rotor. The motor generator can operate in a transducer mode to generate a plurality of torque values, each transmitted to the pedal assembly. A transition between the plurality of torque values can produce a tactile sensation by the pedal assembly. The generator mode and the transducer mode can be operable concurrently and non-concurrently. The vehicle can include a control device. The control device can determine, based on data from a position sensor, a current position of the shaft of the pedal assembly. The control device can determine, based on at least one of a user input or data from a sensor indicative of a current condition of the vehicle, a desired position of the shaft of the pedal assembly. The control device can cause the motor generator to move the shaft of the pedal assembly from the current position to the desired position.

The vehicle can include a position sensor that can determine a rotational position of the pedal relative to a shaft axis of the shaft. The vehicle can include a sensor that can determine an operational status of the vehicle. The control device can determine, based on data from the position sensor, a current position of the shaft of the pedal assembly. The control device can determine, based on data from the sensor, that the operational status of the vehicle is a stop status or a standstill status. The control device can determine, based on the operational status of the vehicle being the stop status or the standstill status, a desired position of the shaft of the pedal assembly. The control device can cause the motor generator to receive electrical current to cause the motor generator to apply a torque value to the shaft to move the shaft of the pedal assembly from the current position to the desired position.

At least one aspect is directed to a vehicle. The vehicle can include a frame. The vehicle can include a first wheel and a second wheel rotatably coupled with the frame. The vehicle can include a drive unit coupled with the frame. The drive unit can include a pedal assembly configured to receive mechanical input from a user. The pedal assembly can include a first pedal, a second pedal, and a shaft. The first pedal and the second pedal can be rotatably coupled with the shaft. The drive unit can include a motor generator coupled with the pedal assembly. The motor generator can include a rotor and windings. The motor generator can operate in a generator mode to generate electrical current based on the mechanical input applied by the user to the pedal assembly. The generator mode can vary an amount of resistive torque exerted on the pedal assembly and an amount of power generated per rotation of the rotor. The motor generator can operate in a transducer mode to generate a plurality of torque values, each transmitted to the pedal assembly. A transition between the plurality of torque values can produce a tactile sensation by the pedal assembly. The generator mode and the transducer mode can be operable concurrently and non-concurrently. The vehicle can include a control device.

The control device can receive a user input to activate a turn signal having an associated direction. The control device can cause the motor generator to operate in the transducer mode to generate the plurality of torque values and to transmit the plurality of torque values to one of the first pedal or the second pedal based on the direction associated with the turn signal.

The vehicle can include a battery coupled with the frame and operatively coupled with the drive unit. The battery can cause the drive unit to rotate the second wheel. The control device can receive data indicative of a state of charge of the battery. The control device can cause the motor generator to operate in the transducer mode to generate the plurality of torque values to produce the tactile sensation by the pedal assembly based on the state of charge of the battery being less than a predefined threshold.

The control device can receive, from the mobile device, an indication that the mobile device has received a notification, The control device can cause the motor generator to operate in the transducer mode to generate the plurality of torque values to produce the tactile sensation by the pedal assembly based on the indication that the mobile device has received the notification. The control device can receive navigation-related information including one or more turns having an associated turning direction. The control device can cause the motor generator to operate in the transducer mode to generate the plurality of torque values and to transmit the plurality of torque values to one of the first pedal or the second pedal based on the turning direction associated with an upcoming turn.

At least one aspect is directed to a vehicle. The vehicle can include a frame. The vehicle can include a first wheel and a second wheel rotatably coupled with the frame. The vehicle can include a drive unit that can rotate the second wheel. The drive unit can be coupled with the frame. The drive unit include a pedal assembly configured to receive a mechanical input from a user. The drive unit can include a motor generator having a rotor and windings. The motor generator can be coupled with the pedal assembly and can exert a resistive torque on the pedal assembly while generating electrical current based on the mechanical input from the user. The vehicle can include a control device configured to vary, based on the pedal assembly moving, current flowing through the windings of the motor generator to vary the resistive torque exerted on the pedal assembly to provide haptic feedback via the pedal assembly. The vehicle can include a current control device or a field-effect transistor coupled with the windings of the motor generator. wherein the control device, to provide the haptic feedback to via the pedal assembly, causes the current control device or the field-effect transistor to vary the electrical current flowing through the windings to vary the resistive torque exerted on the pedal assembly.

The control device can detect, based on data from a sensor, a first surface on which the vehicle is traveling, the first surface having a first noise level. The control device can determine a first plurality of resistive torque values configured to produce first haptic feedback having a first intensity. The control device can detect, based on data from the sensor, a second surface on which the vehicle is traveling, the second surface having a second noise level greater than the first noise level. The control device can determine a second plurality of resistive torque values that can produce second haptic feedback having a second intensity based on the second noise level. The second intensity can be greater than the first intensity. The control device can cause the motor generator provide the second haptic feedback via the pedal assembly based on the detection of the second surface.

At least one aspect is directed to a vehicle. The vehicle can include a frame. The vehicle can include a first wheel and a second wheel rotatably coupled with the frame. The vehicle can include a drive unit that can rotate the second wheel. The drive unit can be coupled with the frame. The drive unit include a pedal assembly configured to receive a mechanical input from a user. The drive unit can include a motor generator having a rotor and windings. The motor generator can be coupled with the pedal assembly and can exert a resistive torque on the pedal assembly while generating electrical current based on the mechanical input from the user. The vehicle can include a control device configured to vary, based on the pedal assembly moving, current flowing through the windings of the motor generator to vary the resistive torque exerted on the pedal assembly to provide haptic feedback via the pedal assembly.

The pedal assembly can include a pedal and a shaft. The pedal can be rotatably coupled with the shaft. The pedal can receive the mechanical input from the user. The control device can determine, based on data from a position sensor, a current position of the shaft of the pedal assembly. The control device can determine, based on at least one of a user input or data from a sensor indicative of a current condition of the vehicle, a desired position of the shaft of the pedal assembly. The control device can cause the motor generator to move the shaft of the pedal assembly from the current position to the desired position.

At least one aspect is directed to a vehicle. The vehicle can include a frame. The vehicle can include a first wheel and a second wheel rotatably coupled with the frame. The vehicle can include a drive unit that can rotate the second wheel. The drive unit can be coupled with the frame. The drive unit include a pedal assembly configured to receive a mechanical input from a user. The pedal assembly can include a first pedal, a second pedal, and a shaft. The first pedal and the second pedal can be rotatably coupled with the shaft. The drive unit can include a motor generator having a rotor and windings. The motor generator can be coupled with the pedal assembly and can exert a resistive torque on the pedal assembly while generating electrical current based on the mechanical input from the user. The vehicle can include a control device configured to vary, based on the pedal assembly moving, current flowing through the windings of the motor generator to vary the resistive torque exerted on the pedal assembly to provide haptic feedback via the pedal assembly. The vehicle can include a battery coupled with the frame and operatively coupled with the drive unit. The battery can cause the drive unit to rotate the second wheel.

The control device can receive data indicative of a state of charge of the battery. The control device can cause the motor generator to operate in the transducer mode to generate the plurality of torque values to produce the tactile sensation by the pedal assembly based on the state of charge of the battery being less than a predefined threshold. The control device can receive a user input to activate a turn signal having an associated direction. The control device can cause the motor generator to operate in the transducer mode to generate the plurality of torque values and to transmit the plurality of torque values to one of the first pedal or the second pedal based on the direction associated with the turn signal. The control device can receive navigation-related information including one or more turns having an associated turning direction. The control device cause the motor generator to provide haptic feedback to one of the first pedal or the second pedal based on the turning direction associated with an upcoming turn.

At least one aspect is directed to a method of manufacturing a vehicle. The method can include providing a frame. The method can include rotatably coupling a first wheel and a second wheel with the frame. The method can include coupling a drive unit with the frame. The can include a pedal assembly configured to receive mechanical input from a user. The drive unit can include a motor generator coupled with the pedal assembly. The motor generator can operate in a generator mode to generate electrical current based on the mechanical input applied by the user to the pedal assembly. The motor generator can operate in a transducer mode to generate a plurality of torque values. Each of the plurality of torque values can be transmitted to the pedal assembly. A transition between the plurality of torque values can produce a tactile sensation by the pedal assembly. The generator mode and the transducer mode can be operable concurrently and non-concurrently.

The plurality of torque values can be a first plurality of torque values and the tactile sensation can be a first tactile sensation having a first intensity. The method can include providing a control device. The method can include detecting, by the control device, a first surface on which the vehicle is traveling. The first surface can have a first noise level. The method can include determining the first plurality of torque values based on the first noise level. The method can include detecting, by the control device, a second surface on which the vehicle is traveling. The second surface can have a second noise level greater than the first noise level. The method can include determining, by the controller, a second plurality of torque values configured to produce a second tactile sensation having a second intensity based on the second noise level. The second intensity can be greater than the first intensity. The method can include causing, by the control device, the motor generator to operate in the transducer mode to generate the second plurality of torque values based on the detection of the second surface.

In various embodiments, the vehicle, which may be a micromobility device, may be designed to support a gross vehicle weight, defined as the combined mass of the device, rider, payload, and accessories, which corresponds to applicable regulatory or industry standards for micromobility devices. By way of example and without limitation, certain bicycle-based and electric bicycle standards, such as ISO 4210 and EN 15194, contemplate testing and design assumptions for a total mass on the order of approximately 120 kilograms, inclusive of rider and load, while other micromobility categories, including scooters, mopeds, and cargo-oriented devices, may be designed for higher gross vehicle weights, such as greater than 120 kilograms, greater than 150 kilograms, or greater than 200 kilograms, depending on jurisdiction, classification, and intended use. In some embodiments, the micromobility device may be configured to comply with regulations and testing protocols, such as those administered by the U.S. Consumer Product Safety Commission, which may specify structural strength, braking performance, and fatigue testing criteria corresponding to representative rider and payload masses. References to such weight values are intended to reflect regulatory examples rather than to impose fixed design limits on the disclosed embodiments.

The propulsion system may include an electric motor, a human-powered drivetrain, or a combination thereof, and may be configured in hub-based, mid-mounted, or remote arrangements using chain, belt, shaft, gear, friction, or direct-drive mechanisms to transmit torque to at least one ground-engaging element. An energy storage system may be provided to store electrical energy for powering the propulsion system and auxiliary components, and may include one or more batteries, capacitors, fuel cells, or other energy storage technologies that may be removable, fixed, swappable, or distributed across multiple locations on the device. The energy storage system may further include charging circuitry, battery management systems, thermal management components, and monitoring elements configured to meet or exceed applicable electrical standards for micromobility devices, including but not limited to UL 2849, UL 2272, IEC 62133, or equivalent regional or international standards.

The micromobility device may further include a control system comprising one or more processors, controllers, sensors, and communication interfaces configured to manage propulsion output, braking behavior, energy usage, and auxiliary functions. The control system may regulate motor output based on rider input, operating conditions, load, speed, inclination, or environmental sensing, and may support software-based features such as diagnostics, data logging, fleet management integration, geofencing, or over-the-air software updates. Braking systems may include mechanical, hydraulic, electromagnetic, regenerative, or combined braking mechanisms, and the device may further include stability or features such as traction control, anti-lock braking, suspension systems, steering dampening elements, lighting systems, and audible warning devices. In various embodiments, the micromobility device may be designed to comply with applicable operational and mechanical standards, including but not limited to ISO 4210, EN 15194, SAE J3194, applicable portions of 16 CFR Part 1512, and corresponding regional, national, or municipal micromobility regulations governing speed, power output, braking performance, lighting, and gross vehicle weight classifications.

The micromobility device may include a rider interface configured to receive user input through handlebars, grips, pedals, throttles, buttons, touch interfaces, or gesture-based controls, and may alternatively or additionally include a payload interface configured to support cargo, delivery containers, child seats, or autonomous payload modules. In some embodiments, the micromobility device may be configured as, or convertible between, multiple micromobility form factors, including electric bicycles, scooters, mopeds, seated or standing ride-on devices, or cargo and utility vehicles, wherein such configurations may share common components or differ only in selected structural, propulsion, control, or interface elements. Unless otherwise stated, the components and features described herein may be combined, omitted, rearranged, scaled, or substituted without departing from the scope of the disclosure, and references to regulatory standards or weight limits are intended to be exemplary and non-limiting.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component” or “data processing apparatus” or the like encompass various apparatuses, devices, and machines for processing data, including, by way of example, a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, and although many of the examples presented herein involve specific combinations of method acts or system elements, those acts and those elements may be combined in other ways to accomplish the same objectives. Acts, elements, and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

Further relative parallel, perpendicular, vertical or other positioning or orientation descriptions include variations within +/-10% or +/-10 degrees of pure vertical, parallel or perpendicular positioning. References to “approximately,” “substantially” or other terms of degree include variations of +/-10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A vehicle, comprising:
a frame;
a first wheel and a second wheel rotatably coupled with the frame;
a drive unit coupled with the frame, the drive unit including:
a pedal assembly configured to receive mechanical input from a user, and
a motor generator coupled with the pedal assembly, the motor generator having a rotor and windings, the motor generator configured to:
operate in a generator mode to generate electrical current based on the mechanical input applied by the user to the pedal assembly, the generator mode configured to vary an amount of resistive torque exerted on the pedal assembly and an amount of power generated per rotation of the rotor;
operate in a transducer mode to generate a plurality of torque values, each transmitted to the pedal assembly, a transition between the plurality of torque values configured to produce a tactile sensation by the pedal assembly, the generator mode and the transducer mode being operable concurrently and non-concurrently.

2. The vehicle of claim 1, comprising:
a current control device or a field-effect transistor coupled with the windings of the motor generator, the current control device or the field-effect transistor configured to vary the electrical current flowing through the windings to vary the resistive torque exerted on the pedal assembly.

3. The vehicle of claim 1, wherein the plurality of torque values is a first plurality of torque values and the tactile sensation is a first tactile sensation having a first intensity, the vehicle comprising:
a control device configured to:
detect, based on data from a sensor, a first surface on which the vehicle is traveling, the first surface having a first noise level;
determine the first plurality of torque values based on the first noise level;
detect, based on data from the sensor, a second surface on which the vehicle is traveling, the second surface having a second noise level greater than the first noise level;
determine a second plurality of torque values configured to produce a second tactile sensation having a second intensity based on the second noise level, the second intensity greater than the first intensity; and
cause the motor generator to operate in the transducer mode to generate the second plurality of torque values based on the detection of the second surface.

4. The vehicle of claim 1, comprising:
the pedal assembly including a pedal and a shaft, the pedal rotatably coupled with the shaft, the pedal configured to receive the mechanical input from the user;
a control device configured to:
determine, based on data from a position sensor, a current position of the shaft of the pedal assembly;
determine, based on at least one of a user input or data from a sensor indicative of a current condition of the vehicle, a desired position of the shaft of the pedal assembly; and
cause the motor generator to move the shaft of the pedal assembly from the current position to the desired position.

5. The vehicle of claim 1, comprising:
the pedal assembly including a pedal and a shaft, the pedal rotatably coupled with the shaft, the pedal configured to receive the mechanical input from the user;
a position sensor configured to determine a rotational position of the pedal relative to a shaft axis of the shaft;
a sensor configured to determine an operational status of the vehicle;
a control device configured to:
determine, based on data from the position sensor, a current position of the shaft of the pedal assembly;
determine, based on data from the sensor, that the operational status of the vehicle is a stop status or a standstill status;
determine, based on the operational status of the vehicle being the stop status or the standstill status, a desired position of the shaft of the pedal assembly; and
cause the motor generator to receive electrical current to cause the motor generator to apply a torque value to the shaft to move the shaft of the pedal assembly from the current position to the desired position.

6. The vehicle of claim 1, comprising:
the pedal assembly including a first pedal, a second pedal, and a shaft, the first pedal and the second pedal rotatably coupled with the shaft;
a control device configured to:
receive a user input to activate a turn signal having an associated direction; and
cause the motor generator to operate in the transducer mode to generate the plurality of torque values and to transmit the plurality of torque values to one of the first pedal or the second pedal based on the direction associated with the turn signal.

7. The vehicle of claim 1, comprising:
a control device communicatively coupled with a mobile device of the user configured to:
receive, from the mobile device, an indication that the mobile device has received a notification; and
cause the motor generator to operate in the transducer mode to generate the plurality of torque values to produce the tactile sensation by the pedal assembly based on the indication that the mobile device has received the notification.

8. The vehicle of claim 1:
the pedal assembly including a first pedal, a second pedal, and a shaft, the first pedal and the second pedal rotatably coupled with the shaft;
a control device configured to:
receive navigation-related information including one or more turns having an associated turning direction; and
cause the motor generator to operate in the transducer mode to generate the plurality of torque values and to transmit the plurality of torque values to one of the first pedal or the second pedal based on the turning direction associated with an upcoming turn.

9. The vehicle of claim 1, comprising:
a battery coupled with the frame and operatively coupled with the drive unit, the battery configured to cause the drive unit to rotate the second wheel;
a control device configured to:
receive data indicative of a state of charge of the battery; and
cause the motor generator to operate in the transducer mode to generate the plurality of torque values to produce the tactile sensation by the pedal assembly based on the state of charge of the battery being less than a predefined threshold.

10. A vehicle, comprising:
a frame;
a first wheel and a second wheel rotatably coupled with the frame;
a drive unit to rotate the second wheel, the drive unit coupled with the frame and including:
a pedal assembly configured to receive a mechanical input from a user; and
a motor generator having a rotor and windings, the motor generator coupled with the pedal assembly and configured to exert a resistive torque on the pedal assembly while generating electrical current based on the mechanical input from the user; and
a control device configured to vary, based on the pedal assembly moving, current flowing through the windings of the motor generator to vary the resistive torque exerted on the pedal assembly to provide haptic feedback via the pedal assembly.

11. The vehicle of claim 1, comprising:
a current control device or a field-effect transistor coupled with the windings of the motor generator, wherein the control device, to provide the haptic feedback to via the pedal assembly, causes the current control device or the field-effect transistor to vary the electrical current flowing through the windings to vary the resistive torque exerted on the pedal assembly.

12. The vehicle of claim 10, comprising:
the control device configured to:
detect, based on data from a sensor, a first surface on which the vehicle is traveling, the first surface having a first noise level;
determine a first plurality of resistive torque values configured to produce first haptic feedback having a first intensity;
detect, based on data from the sensor, a second surface on which the vehicle is traveling, the second surface having a second noise level greater than the first noise level;
determine a second plurality of resistive torque values configured to produce second haptic feedback having a second intensity based on the second noise level, the second intensity greater than the first intensity; and
cause the motor generator provide the second haptic feedback via the pedal assembly based on the detection of the second surface.

13. The vehicle of claim 10, comprising:
the pedal assembly including a pedal and a shaft, the pedal rotatably coupled with the shaft, the pedal configured to receive the mechanical input from the user;
the control device configured to:
determine, based on data from a position sensor, a current position of the shaft of the pedal assembly;
determine, based on at least one of a user input or data from a sensor indicative of a current condition of the vehicle, a desired position of the shaft of the pedal assembly; and
supply electrical energy to the motor generator to cause the motor generator to move the shaft of the pedal assembly from the current position to the desired position.

14. The vehicle of claim 10, comprising:
the pedal assembly including a pedal and a shaft, the pedal rotatably coupled with the shaft, the pedal configured to receive the mechanical input from the user;
a position sensor configured to determine a rotational position of the pedal relative to a shaft axis of the shaft;
a sensor configured to determine an operational status of the vehicle;
the control device configured to:
determine, based on data from the position sensor, a current position of the shaft of the pedal assembly;
determine, based on data from the sensor, that the operational status of the vehicle is a stop status or a standstill status;
determine, based on the operational status of the vehicle being the stop status or the standstill status, a desired position of the shaft of the pedal assembly; and
supply electrical energy to the motor generator to cause the motor generator to move the shaft of the pedal assembly from the current position to the desired position.

15. The vehicle of claim 10, comprising:
the pedal assembly including a first pedal, a second pedal, and a shaft, the first pedal and the second pedal rotatably coupled with the shaft;
the control device configured to:
receive a user input to activate a turn signal having an associated direction; and
cause the motor generator to provide haptic feedback to one of the first pedal or the second pedal based on the direction associated with the turn signal.

16. The vehicle of claim 10, comprising:
the control device communicatively coupled with a mobile device of the user configured to:
receive, from the mobile device, an indication that the mobile device has received a notification; and
cause the motor generator to provide haptic feedback to the pedal assembly based on the indication that the mobile device has received the notification.

17. The vehicle of claim 10, comprising:
a battery coupled with the frame and operatively coupled with the drive unit, the battery configured to cause the drive unit to rotate the second wheel;
the control device configured to:
receive data indicative of a state of charge of the battery; and
cause the motor generator to provide haptic feedback based on the state of charge of the battery being less than a predefined threshold.

18. The vehicle of claim 10, comprising:
the pedal assembly including a first pedal, a second pedal, and a shaft, the first pedal and the second pedal rotatably coupled with the shaft;
the control device configured to:
receive navigation-related information including one or more turns having an associated turning direction; and
cause the motor generator to provide haptic feedback to one of the first pedal or the second pedal based on the turning direction associated with an upcoming turn.

19. A method of manufacturing a vehicle, comprising:
providing a frame;
rotatably coupling a first wheel and a second wheel with the frame; and
coupling a drive unit with the frame, the drive unit including a pedal assembly configured to receive mechanical input from a user, and a motor generator coupled with the pedal assembly, the motor generator configured to:
operate in a generator mode to generate electrical current based on the mechanical input applied by the user to the pedal assembly; and
operate in a transducer mode to generate a plurality of torque values, each transmitted to the pedal assembly, a transition between the plurality of torque values configured to produce a tactile sensation by the pedal assembly, the generator mode and the transducer mode being operable concurrently and non-concurrently.

20. The method of claim 19, wherein the plurality of torque values is a first plurality of torque values and the tactile sensation is a first tactile sensation having a first intensity, the method comprising:
providing a control device;
detecting, by the control device, a first surface on which the vehicle is traveling, the first surface having a first noise level;
determining the first plurality of torque values based on the first noise level;
detecting, by the control device, a second surface on which the vehicle is traveling, the second surface having a second noise level greater than the first noise level;
determining, by the control device, a second plurality of torque values configured to produce a second tactile sensation having a second intensity based on the second noise level, the second intensity greater than the first intensity; and
causing, by the control device, the motor generator to operate in the transducer mode to generate the second plurality of torque values based on the detection of the second surface.
